(19) United States
(12) Patent Application Publication
(10) Pub. No.: US 2019/0107406 A1
(43) Pub. Date: Apr. 11, 2019

(54) SYSTEMS AND METHODS FOR TRIP PLANNING UNDER UNCERTAINTY

(71) Applicant: NIO USA, Inc., San Jose, CA (US)

(72) Inventors: Jonathan A. Cox, San Jose, CA (US); Marzieh Parandehgheibi, San Jose, CA (US); Zhou Xing, San Jose, CA (US); Cong Zhao, Stanford, CA (US); Gautam Muralidhar, San Jose, CA (US); Nilesh V. Kulkarni, Saratoga, CA (US); Christopher F. Pouliot, San Mateo, CA (US); Abhishek Singhal, Santa Clara, CA (US)

(21) Appl. No.: 15/727,838

(22) Filed: Oct. 9, 2017

(51) Int. Cl. G01C 21/34; G01C 21/36; B60L 11/18; G01S 19/42

(52) U.S. Cl. CPC G01C 21/3469; G01C 21/3492; G01C 21/343; G01C 21/3679; G01C 21/3697; B60L 11/1861; G01S 19/42; G01C 21/3667; G01C 21/3446

(57) ABSTRACT

Systems of an electrical vehicle and the operations thereof are provided. Electric vehicles may be routed from a start location to a destination through a network of charging stations explicitly considering time-varying uncertainty in both charging times, queueing times, and range. The routing objective may be a function of trip duration, electric vehicle state of charge at any time or location along the trip, uncertainty in the vehicle state of charge, the estimated trip duration, etc. Uncertainty in a distribution may be computed using an information-theoretic metric such as entropy. Waiting times may be estimated at an electric vehicle charging station given observed data for that station. An estimated waiting time at a charging station can be communicated directly to the owner of an electric vehicle owner or used to design a robust system for routing through charging stations.

### FIELD

The present disclosure is generally directed to vehicle systems, in particular, toward systems and methods of smart electric vehicle trip planning under uncertainty.

### BACKGROUND

In recent years, transportation methods have changed substantially. This change is due in part to a concern over the limited availability of natural resources, a proliferation in personal technology, and a societal shift to adopt more environmentally friendly transportation solutions. These considerations have encouraged the development of a number of new flexible-fuel vehicles, hybrid-electric vehicles, and electric vehicles.

While these vehicles appear to be new they are generally implemented as a number of traditional subsystems that are merely tied to an alternative power source. In fact, the design and construction of the vehicles is limited to standard frame sizes, shapes, materials, and transportation concepts. Among other things, these limitations fail to take advantage of the benefits of new technology, power sources, and support infrastructure.

Conventional methods of addressing vehicle routing under various constraints fail to provide an electric vehicle routing solution that explicitly takes into account uncertainty in quantities like waiting time, charging time, and vehicle state of charge.

### BRIEF DESCRIPTION OF THE DRAWINGS

FIG. 1 shows a vehicle in accordance with embodiments of the present disclosure;

FIG. 2 shows a vehicle in an environment in accordance with embodiments of the present disclosure;

FIG. 3 is a diagram of an embodiment of a data structure for storing information about a vehicle in an environment;

FIG. 4A shows a vehicle in a user environment in accordance with embodiments of the present disclosure;

FIG. 4B shows a vehicle in a fleet management and automated operation environment in accordance with embodiments of the present disclosure;

FIG. 4C shows an embodiment of the instrument panel of the vehicle according to one embodiment of the present disclosure;

FIG. 5 shows charging areas associated with an environment in accordance with embodiments of the present disclosure;

FIG. 6 shows a vehicle in a roadway charging environment in accordance with embodiments of the present disclosure;

FIG. 7 shows a vehicle in a robotic charging station environment in accordance with another embodiment of the present disclosure;

FIG. 8 shows a vehicle in an overhead charging environment in accordance with another embodiment of the present disclosure;

FIG. 9 shows a vehicle in a roadway environment comprising roadway vehicles in accordance with another embodiment of the present disclosure;

FIG. 10 shows a vehicle in an aerial vehicle charging environment in accordance with another embodiment of the present disclosure;

FIG. 11 shows a vehicle in an emergency charging environment in accordance with embodiments of the present disclosure;

FIG. 12 is a perspective view of a vehicle in accordance with embodiments of the present disclosure;

FIG. 13 is a plan view of a vehicle in accordance with at least some embodiments of the present disclosure;

FIG. 14 is a plan view of a vehicle in accordance with embodiments of the present disclosure;

FIG. 15 is a block diagram of an embodiment of an electrical system of the vehicle;

FIG. 16 is a block diagram of an embodiment of a power generation unit associated with the electrical system of the vehicle;

FIG. 17 is a block diagram of an embodiment of power storage associated with the electrical system of the vehicle;

FIG. 18 is a block diagram of an embodiment of loads associated with the electrical system of the vehicle;

FIG. 19A is a block diagram of an exemplary embodiment of a communications subsystem of the vehicle;

FIG. 19B is a block diagram of a computing environment associated with the embodiments presented herein;

FIG. 19C is a block diagram of a computing device associated with one or more components described herein;

FIG. 20 is a block diagram of a cloud-based system for providing map information to a vehicle according to an embodiment;

FIG. 21 is a block diagram of an on board navigation system according to an embodiment;

FIG. 22 is a screen shot of an on board navigation display according to an embodiment;

FIG. 23 is a flow chart of processor executable instructions according to an embodiment;

FIG. 24 is a flow chart of processor executable instructions according to an embodiment;

FIG. 25 is a block diagram of a computational system according to an embodiment;

FIG. 26 is a flow chart of processor executable instructions according to an embodiment;

FIG. 27 is a flow chart of processor executable instructions in continuation of FIG. 26 according to an embodiment; and

FIG. 28 is a flow chart of processor executable instructions according to an embodiment.

### DETAILED DESCRIPTION

Embodiments of the present disclosure will be described in connection with a vehicle, and in accordance with one exemplary embodiment an electric vehicle and/or hybrid-electric vehicle and associated systems.

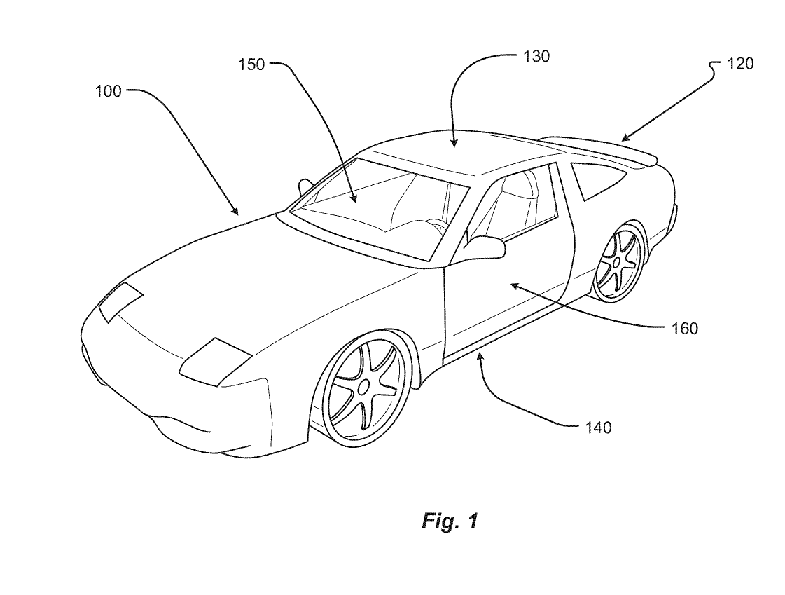

With attention to FIGS. 1-11, embodiments of the electric vehicle system 10 and method of use are depicted.

Referring to FIG. 1, the electric vehicle system comprises electric vehicle 100. The electric vehicle 100 comprises vehicle front 110, vehicle aft 120, vehicle roof 130, vehicle side 160, vehicle undercarriage 140 and vehicle interior 150.

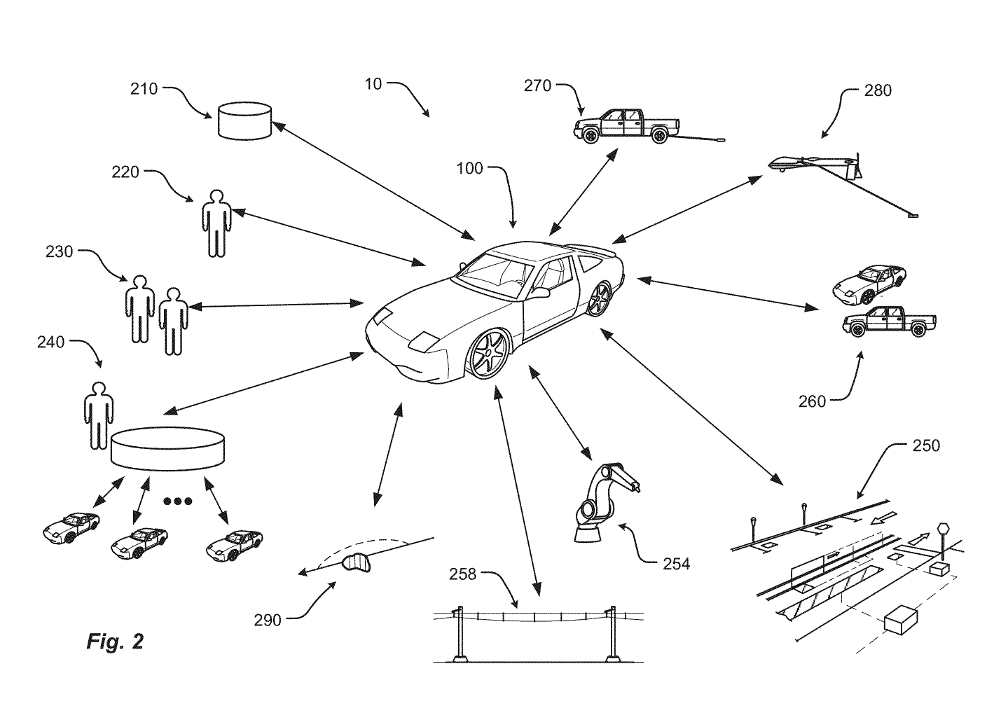

Referring to FIG. 2, the vehicle 100 is depicted in a plurality of exemplary environments. The vehicle 100 may operate in any one or more of the depicted environments in any combination. Other embodiments are possible but are not depicted in FIG. 2. Generally, the vehicle 100 may operate in environments which enable charging of the vehicle 100 and/or operation of the vehicle 100. More specifically, the vehicle 100 may receive a charge via one or more means comprising emergency charging vehicle system 270, aerial vehicle charging system 280, roadway system 250, robotic charging system 254 and overhead charging system 258. The vehicle 100 may interact and/or operate in an environment comprising one or more other roadway vehicles 260. The vehicle 100 may engage with elements within the vehicle 100 comprising vehicle driver 220, vehicle passengers 220 and vehicle database 210. In one embodiment, vehicle database 210 does not physically reside in the vehicle 100 but is instead accessed remotely, e.g. by wireless communication, and resides in another location such as a residence or business location. Vehicle 100 may operate autonomously and/or semi-autonomously in an autonomous environment 290 (here, depicted as a roadway environment presenting a roadway obstacle of which the vehicle 100 autonomously identifies and steers the vehicle 100 clear of the obstacle). Furthermore, the vehicle 100 may engage with a remote operator system 240, which may provide fleet management instructions or control.

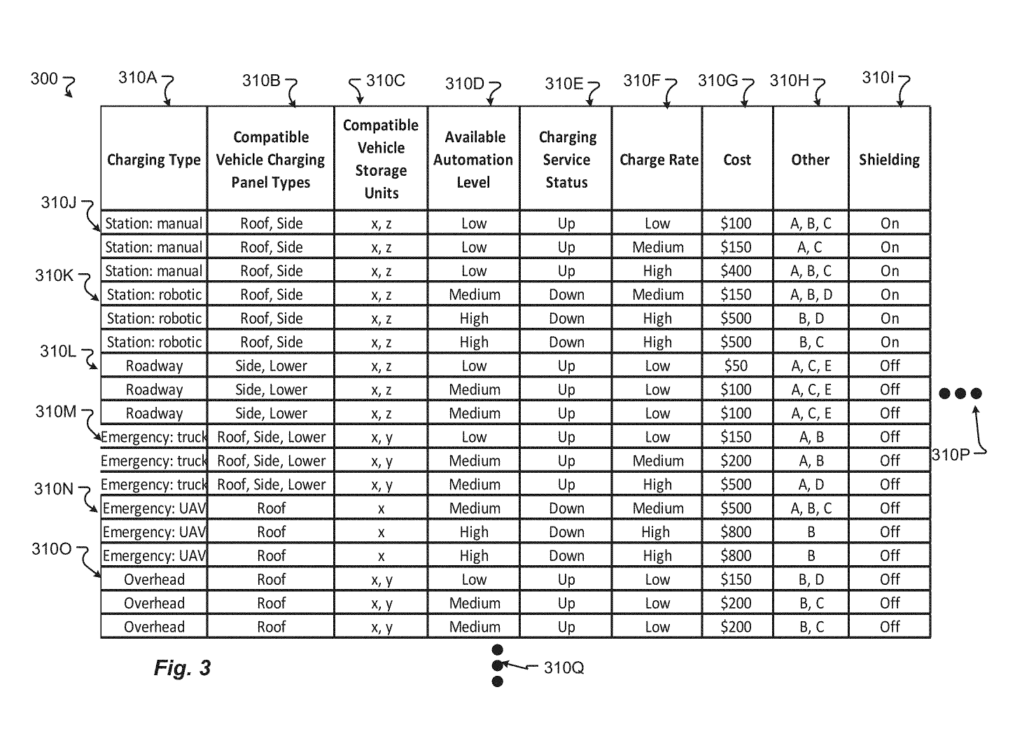

FIG. 3 is a diagram of an embodiment of a data structure 300 for storing information about a vehicle 100 in an environment. The data structure may be stored in vehicle database 210. Generally, data structure 300 identifies operational data associated with charging types 310A. The data structures 300 may be accessible by a vehicle controller. The data contained in data structure 300 enables, among other things, for the vehicle 100 to receive a charge from a given charging type.

Data may comprise charging type 310A comprising a manual charging station 310J, robotic charging station 310K such as robotic charging system 254, a roadway charging system 310L such as those of roadway system 250, an emergency charging system 310M such as that of emergency charging vehicle system 270, an emergency charging system 310N such as that of aerial vehicle charging system 280, and overhead charging type 3100 such as that of overhead charging system 258.

Compatible vehicle charging panel types 310B comprise locations on vehicle 100 wherein charging may be received, such as vehicle roof 130, vehicle side 160 and vehicle lower or undercarriage 140. Compatible vehicle storage units 310C data indicates storage units types that may receive power from a given charging type 310A. Available automation level 310D data indicates the degree of automation available for a given charging type; a high level may indicate full automation, allowing the vehicle driver 220 and/or vehicle passengers 230 to not involve themselves in charging operations, while a low level of automation may require the driver 220 and/or occupant 230 to manipulate/position a vehicle charging device to engage with a particular charging type 310A to receive charging. Charging status 310E indicates whether a charging type 310A is available for charging (i.e. is “up”) or is unavailable for charging (i.e. is “down”). Charge rate 310F provides a relative value for time to charge, while Cost 310G indicates the cost to vehicle 100 to receive a given charge. The Other data element 310H may provide additional data relevant to a given charging type 310A, such as a recommended separation distance between a vehicle charging plate and the charging source. The Shielding data element 310I indicates if electromagnetic shielding is recommended for a given charging type 310A and/or charging configuration. Further data fields 310P, 310Q are possible.

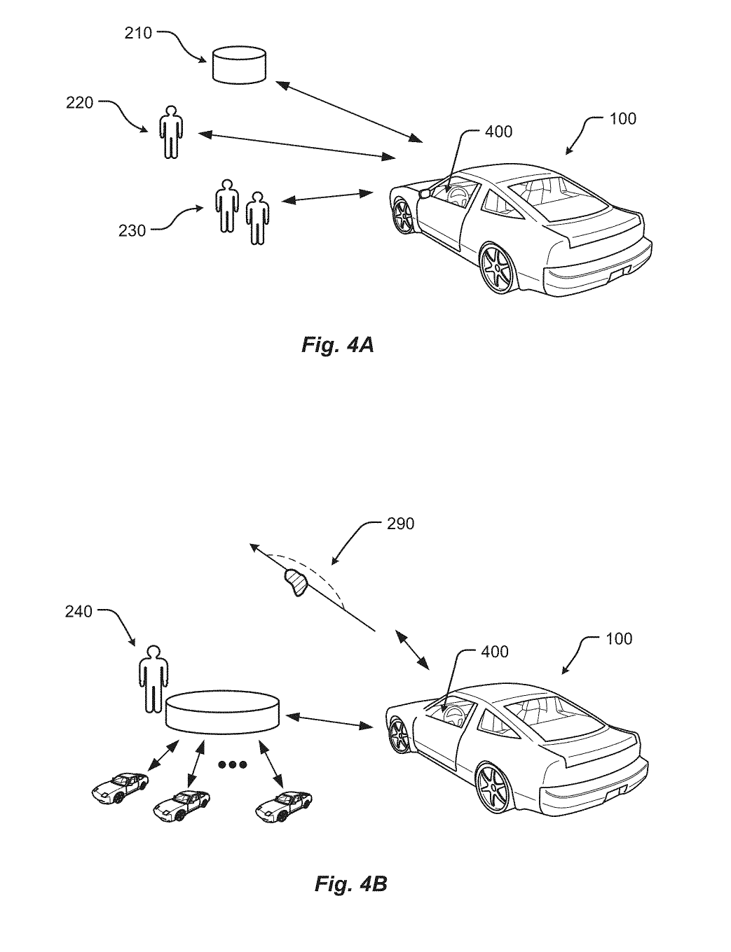

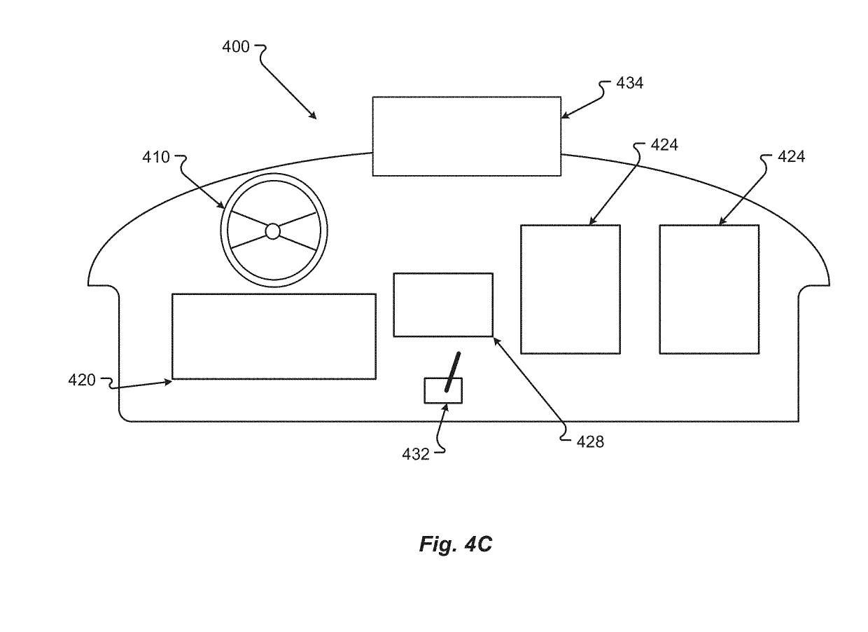

FIG. 4A depicts the vehicle 100 in a user environment comprising vehicle database 210, vehicle driver 220 and vehicle passengers 230. Vehicle 100 further comprises vehicle instrument panel 400 to facilitate or enable interactions with one or more of vehicle database 210, vehicle driver 220 and vehicle passengers 230. In one embodiment, driver 210 interacts with instrument panel 400 to query database 210 so as to locate available charging options and to consider or weigh associated terms and conditions of the charging options. Once a charging option is selected, driver 210 may engage or operate a manual control device (e.g., a joystick) to position a vehicle charging receiver panel so as to receive a charge.

FIG. 4B depicts the vehicle 100 in a user environment comprising a remote operator system 240 and an autonomous driving environment 290. In the remote operator system 240 environment, a fleet of electric vehicles 100 (or mixture of electric and non-electric vehicles) is managed and/or controlled remotely. For example, a human operator may dictate that only certain types of charging types are to be used, or only those charging types below a certain price point are to be used. The remote operator system 240 may comprise a database comprising operational data, such as fleet-wide operational data. In another example, the vehicle 100 may operate in an autonomous driving environment 290 wherein the vehicle 100 is operated with some degree of autonomy, ranging from complete autonomous operation to semi-automation wherein only specific driving parameters (e.g., speed control or obstacle avoidance) are maintained or controlled autonomously. In FIG. 4B, autonomous driving environment 290 depicts an oil slick roadway hazard that triggers that triggers the vehicle 100, while in an automated obstacle avoidance mode, to automatically steer around the roadway hazard.

FIG. 4C shows one embodiment of the vehicle instrument panel 400 of vehicle 100.

Instrument panel 400 of vehicle 100 comprises steering wheel 410, vehicle operational display 420 (which would provide basic driving data such as speed), one or more auxiliary displays 424 (which may display, e.g., entertainment applications such as music or radio selections), heads-up display 434 (which may provide, e.g., guidance information such as route to destination, or obstacle warning information to warn of a potential collision, or some or all primary vehicle operational data such as speed), power management display 428 (which may provide, e.g., data as to electric power levels of vehicle 100), and charging manual controller 432 (which provides a physical input, e.g. a joystick, to manual maneuver, e.g., a vehicle charging plate to a desired separation distance). One or more of displays of instrument panel 400 may be touch-screen displays. One or more displays of instrument panel 400 may be mobile devices and/or applications residing on a mobile device such as a smart phone.

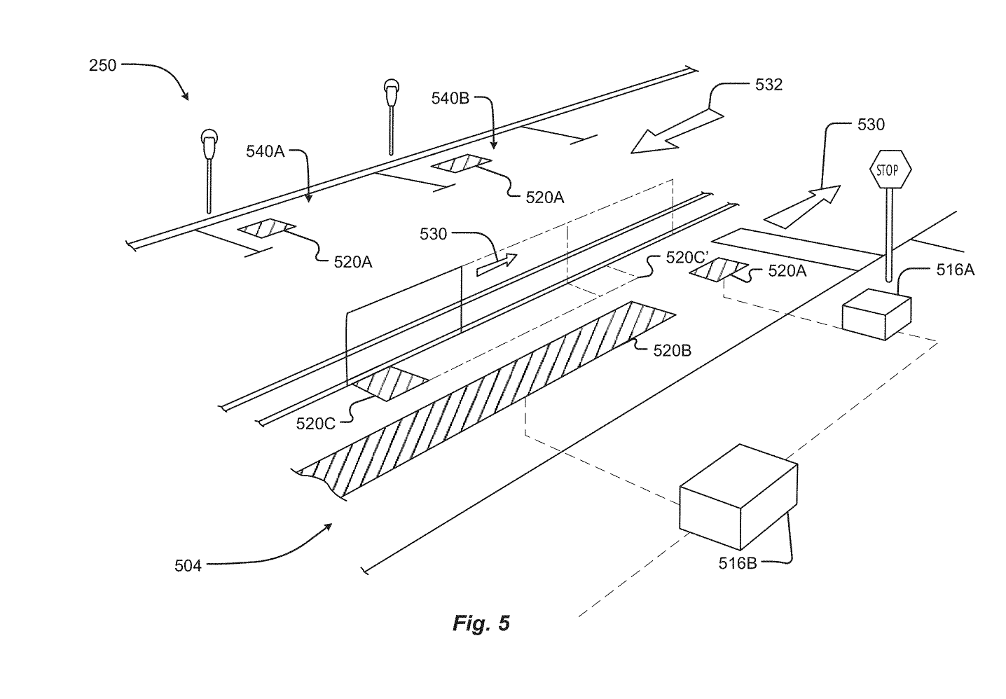

FIG. 5 depicts a charging environment of a roadway charging system 250. The charging area may be in the roadway 504, on the roadway 504, or otherwise adjacent to the roadway 504, and/or combinations thereof. This static charging area 520B may allow a charge to be transferred even while the electrical vehicle 100 is moving. For example, the static charging area 520B may include a charging transmitter (e.g., conductor, etc.) that provides a transfer of energy when in a suitable range of a receiving unit (e.g., an inductor pick up, etc.). In this example, the receiving unit may be a part of the charging panel associated with the electrical vehicle 100.

The static charging areas 520A, 520B may be positioned a static area such as a designated spot, pad, parking space 540A, 540B, traffic controlled space (e.g., an area adjacent to a stop sign, traffic light, gate, etc.), portion of a building, portion of a structure, etc., and/or combinations thereof. Some static charging areas may require that the electric vehicle 100 is stationary before a charge, or electrical energy transfer, is initiated. The charging of vehicle 100 may occur by any of several means comprising a plug or other protruding feature. The power source 516A, 516B may include a receptacle or other receiving feature, and/or vice versa.

The charging area may be a moving charging area 520C. Moving charging areas 520C may include charging areas associated with one or more portions of a vehicle, a robotic charging device, a tracked charging device, a rail charging device, etc., and/or combinations thereof. In a moving charging area 520C, the electrical vehicle 100 may be configured to receive a charge, via a charging panel, while the vehicle 100 is moving and/or while the vehicle 100 is stationary. In some embodiments, the electrical vehicle 100 may synchronize to move at the same speed, acceleration, and/or path as the moving charging area 520C. In one embodiment, the moving charging area 520C may synchronize to move at the same speed, acceleration, and/or path as the electrical vehicle 100. In any event, the synchronization may be based on an exchange of information communicated across a communications channel between the electric vehicle 100 and the charging area 520C. Additionally or alternatively, the synchronization may be based on information associated with a movement of the electric vehicle 100 and/or the moving charging area 520C. In some embodiments, the moving charging area 520C may be configured to move along a direction or path 532 from an origin position to a destination position 520C′.

In some embodiments, a transformer may be included to convert a power setting associated with a main power supply to a power supply used by the charging areas 520A-C. For example, the transformer may increase or decrease a voltage associated with power supplied via one or more power transmission lines.

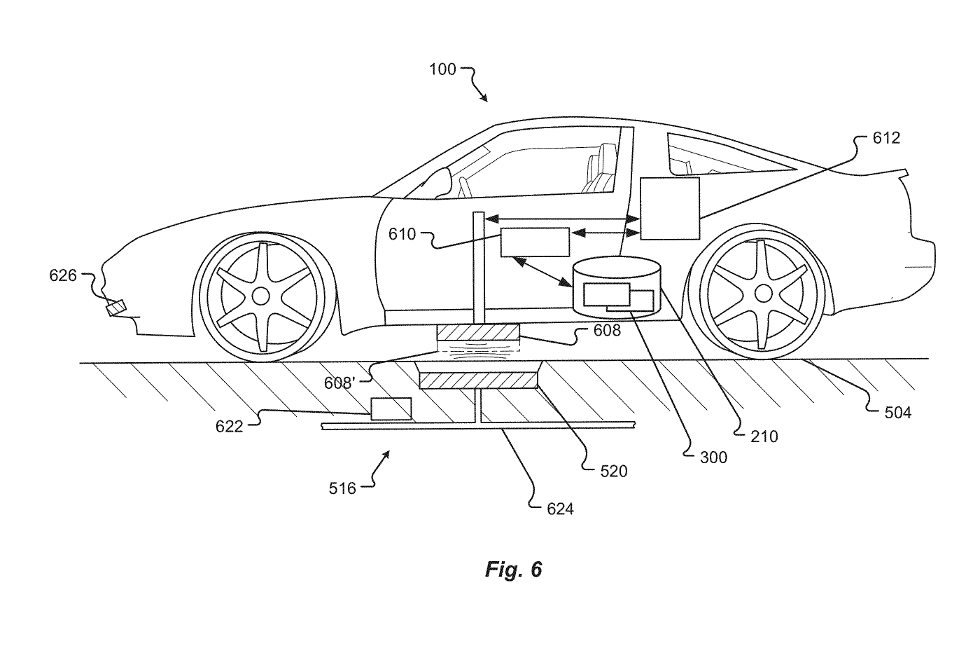

Referring to FIG. 6, a vehicle 100 is shown in a charging environment in accordance with embodiments of the present disclosure. The system 10 comprises a vehicle 100, an electrical storage unit 612, an external power source 516 able to provide a charge to the vehicle 100, a charging panel 608 mounted on the vehicle 100 and in electrical communication with the electrical storage unit 612, and a vehicle charging panel controller 610. The charging panel controller 610 may determine if the electrical storage unit requires charging and if conditions allow for deployment of a charging panel. The vehicle charging panel 608 may operate in at least a retracted state and a deployed state (608 and 608′ as shown is FIG. 6), and is movable by way of an armature.

The charging panel controller 610 may receive signals from vehicle sensors 626 to determine, for example, if a hazard is present in the path of the vehicle 100 such that deployment of the vehicle charging panel 608 is inadvisable. The charging panel controller 610 may also query vehicle database 210 comprising data structures 300 to establish other required conditions for deployment. For example, the database may provide that a particular roadway does not provide a charging service or the charging service is inactive, wherein the charging panel 108 would not be deployed.

The power source 516 may include at least one electrical transmission line 624 and at least one power transmitter or charging area 520. During a charge, the charging panel 608 may serve to transfer energy from the power source 516 to at least one energy storage unit 612 (e.g., battery, capacitor, power cell, etc.) of the electric vehicle 100.

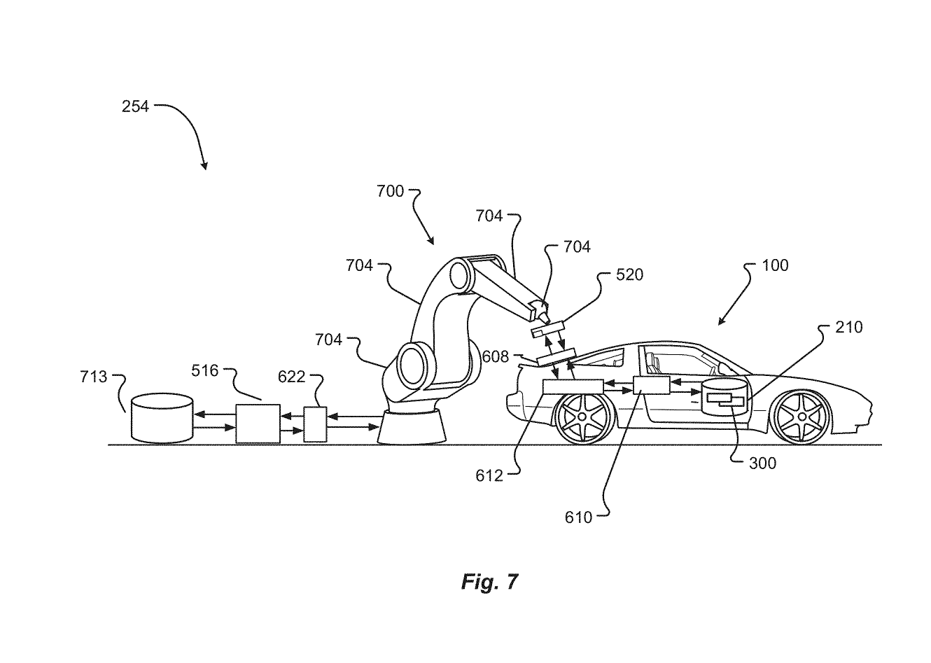

FIG. 7 shows a vehicle 100 in a charging station environment 254 in accordance with another embodiment of the present disclosure. Generally, in this embodiment of the disclosure, charging occurs from a robotic unit 700.

Robotic charging unit 700 comprises one or more robotic unit arms 704, at least one robotic unit arm 704 interconnected with charging plate 520. The one or more robotic unit arms 704 maneuver charging plate 520 relative to charging panel 608 of vehicle 100. Charging plate 520 is positioned to a desired or selectable separation distance, as assisted by a separation distance sensor disposed on charging plate 520. Charging plate 520 may remain at a finite separation distance from charging panel 608, or may directly contact charging panel (i.e. such that separation distance is zero). Charging may be by induction. In alternative embodiments, separation distance sensor is alternatively or additionally disposed on robotic arm 704. Vehicle 100 receives charging via charging panel 608 which in turn charges energy storage unit 612. Charging panel controller 610 is in communication with energy storage unit 612, charging panel 608, vehicle database 300, charge provider controller 622, and/or any one of elements of instrument panel 400.

Robotic unit further comprises, is in communication with and/or is interconnected with charge provider controller 622, power source 516 and a robotic unit database. Power source 516 supplies power, such as electrical power, to charge plate 520 to enable charging of vehicle 100 via charging panel 608. Controller 622 maneuvers or operates robotic unit 704, either directly and/or completely or with assistance from a remote user, such as a driver or passenger in vehicle 100 by way of, in one embodiment, charging manual controller 432.

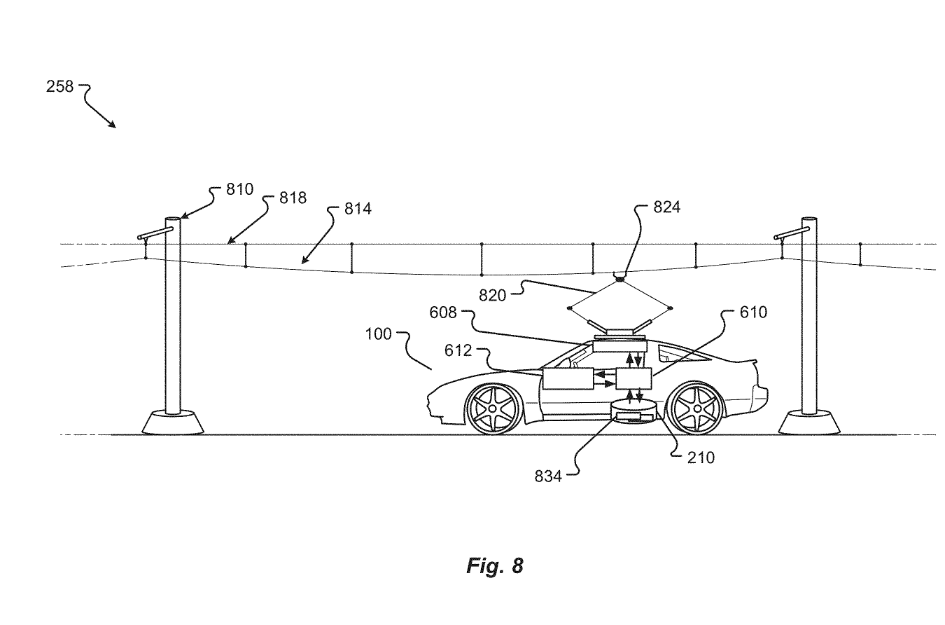

FIG. 8 shows a vehicle 100 in an overhead charging environment in accordance with another embodiment of the present disclosure. Generally, in this embodiment of the disclosure, charging occurs from an overhead towered charging system 258, similar to existing commuter rail systems. Such an overhead towered system 258 may be easier to build and repair compared to in-roadway systems. Generally, the disclosure includes a specially-designed overhead roadway charging system comprising an overhead charging cable or first wire 814 that is configured to engage an overhead contact 824 which provides charge to charging panel 608 which provides charge to vehicle energy storage unit 612. The overhead towered charging system 258 may further comprise second wire 818 to provide stability and structural strength to the roadway charging system 800. The first wire 814 and second wire 818 are strung between towers 810.

The overhead charging cable or first wire 814 is analogous to a contact wire used to provide charging to electric trains or other vehicles. An external source provides or supplies electrical power to the first wire 814. The charge provider comprises an energy source i.e. a provider battery and a provider charge circuit or controller in communication with the provider battery. The overhead charging cable or first wire 814 engages the overhead contact 824 which is in electrical communication with charge receiver panel 108. The overhead contact 824 may comprise any known means to connect to overhead electrical power cables, such as a pantograph 820, a bow collector, a trolley pole or any means known to those skilled in the art. Further disclosure regarding electrical power or energy transfer via overhead systems is found in US Pat. Publ. No. 2013/0105264 to Ruth entitled “Pantograph Assembly,” the entire contents of which are incorporated by reference for all purposes. In one embodiment, the charging of vehicle 100 by overhead charging system 800 via overhead contact 824 is by any means know to those skilled in the art, to include those described in the above-referenced US Pat. Publ. No. 2013/0105264 to Ruth.

The overhead contact 824 presses against the underside of the lowest overhead wire of the overhead charging system, i.e. the overhead charging cable or first wire 814, aka the contact wire. The overhead contact 824 may be electrically conductive. Alternatively or additionally, the overhead contact 824 may be adapted to receive electrical power from overhead charging cable or first wire 814 by inductive charging.

In one embodiment, the receipt and/or control of the energy provided via overhead contact 824 (as connected to the energy storage unit 612) is provided by receiver charge circuit or charging panel controller 110.

Overhead contact 824 and/or charging panel 608 may be located anywhere on vehicle 100, to include, for example, the roof, side panel, trunk, hood, front or rear bumper of the charge receiver 100 vehicle, as long as the overhead contact 824 may engage the overhead charging cable or first wire 814. Charging panel 108 may be stationary (e.g. disposed on the roof of vehicle 100) or may be moveable, e.g. moveable with the pantograph 820. Pantograph 820 may be positioned in at least two states comprising retracted and extended. In the extended state pantograph 820 engages first wire 814 by way of the overhead contact 824. In the retracted state, pantograph 820 may typically reside flush with the roof of vehicle 100 and extend only when required for charging. Control of the charging and/or positioning of the charging plate 608, pantograph 820 and/or overhead contact 824 may be manual, automatic or semi-automatic (such as via controller 610); said control may be performed through a GUI engaged by driver or occupant of receiving vehicle 100 and/or driver or occupant of charging vehicle.

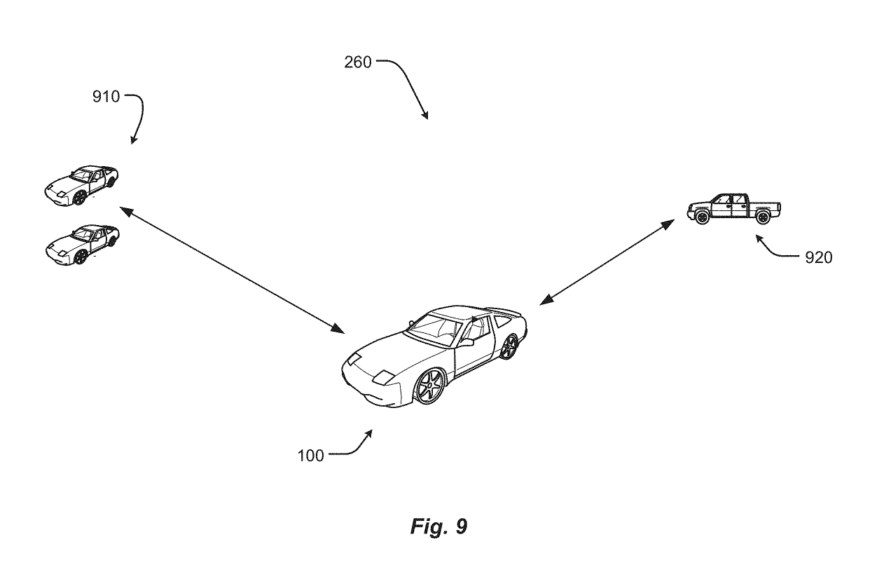

FIG. 9 shows a vehicle in a roadway environment comprising roadway vehicles 260 in accordance with another embodiment of the present disclosure. Roadway vehicles 260 comprise roadway passive vehicles 910 and roadway active vehicles 920. Roadway passive vehicles 910 comprise vehicles that are operating on the roadway of vehicle 100 but do no cooperatively or actively engage with vehicle 100. Stated another way, roadway passive vehicles 910 are simply other vehicles operating on the roadway with the vehicle 100 and must be, among other things, avoided (e.g., to include when vehicle 100 is operating in an autonomous or semi-autonomous manner). In contrast, roadway active vehicles 920 comprise vehicles that are operating on the roadway of vehicle 100 and have the capability to, or actually are, actively engaging with vehicle 100. For example, the emergency charging vehicle system 270 is a roadway active vehicle 920 in that it may cooperate or engage with vehicle 100 to provide charging. In some embodiments, vehicle 100 may exchange data with a roadway active vehicle 920 such as, for example, data regarding charging types available to the roadway active vehicle 920.

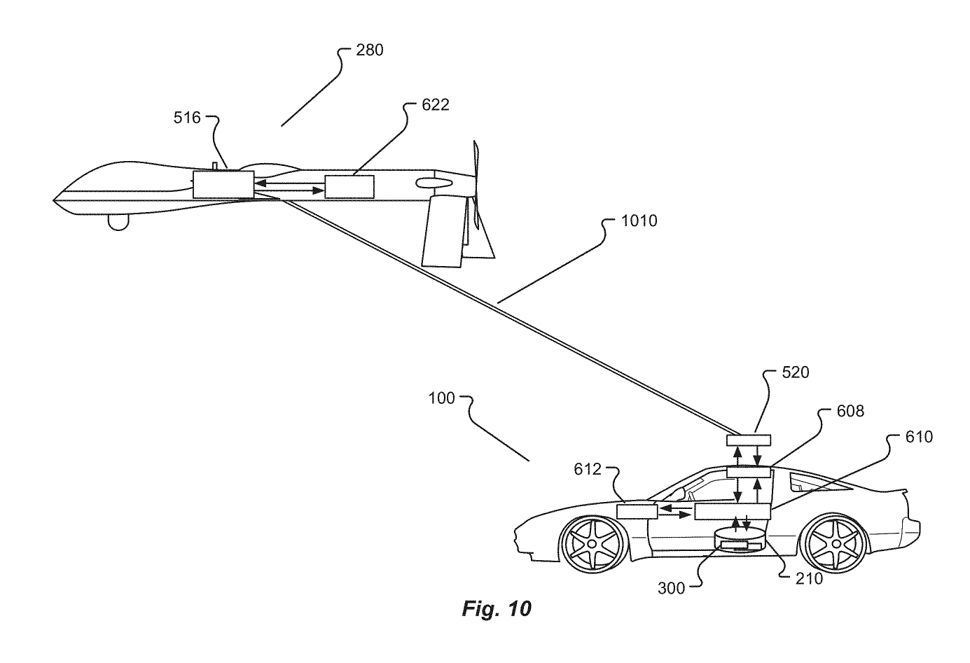

FIG. 10 shows a vehicle in an aerial vehicle charging environment in accordance with another embodiment of the present disclosure. Generally, this embodiment involves an aerial vehicle (“AV”), such as an Unmanned Aerial Vehicle (UAV), flying over or near a vehicle to provide a charge. The UAV may also land on the car to provide an emergency (or routine) charge. Such a charging scheme may be particularly suited for operations in remote areas, in high traffic situations, and/or when the car is moving. The AV may be a specially-designed UAV, aka RPV or drone, with a charging panel that can extend from the AV to provide a charge. The AV may include a battery pack and a charging circuit to deliver a charge to the vehicle. The AV may be a manned aerial vehicle, such as a piloted general aviation aircraft, such as a Cessna 172.

With reference to FIG. 10, an exemplar embodiment of a vehicle charging system 100 comprising a charge provider configured as an aerial vehicle 280, the aerial vehicle 280 comprising a power source 516 and charge provider controller 622. The AV may be semi-autonomous or fully autonomous. The AV may have a remote pilot/operator providing control inputs. The power source 516 is configured to provide a charge to a charging panel 608 of vehicle 100. The power source 516 is in communication with the charge provider controller 622. The aerial vehicle 280 provides a tether 1010 to deploy or extend charging plate 520 near to charging panel 608. The tether 1010 may comprise a chain, rope, rigid or semi-rigid tow bar or any means to position charging plate 520 near charging panel 608. For example, tether 1010 may be similar to a refueling probe used by airborne tanker aircraft when refueling another aircraft.

In one embodiment, the charging plate 520 is not in physical interconnection to AV 280, that is, there is no tether 1010. In this embodiment, the charging plate 520 is positioned and controlled by AV 280 by way of a controller on AV 280 or in communication with AV 280.

In one embodiment, the charging plate 520 position and/or characteristics (e.g. charging power level, flying separation distance, physical engagement on/off) are controlled by vehicle 100 and/or a user in or driver of vehicle 100.

Charge or power output of power source 516 is provided or transmitted to charger plate 620 by way of a charging cable or wire, which may be integral to tether 1010. In one embodiment, the charging cable is non-structural, that is, it provides zero or little structural support to the connection between AV 280 and charger plate 520.

Charging panel 608 of vehicle 100 receives power from charger plate 520. Charging panel 608 and charger plate 520 may be in direct physical contact (termed a “contact” charger configuration) or not in direct physical contact (termed a “flyer” charger configuration), but must be at or below a threshold (separation) distance to enable charging, such as by induction. Energy transfer or charging from the charger plate 520 to the charging panel 608 is inductive charging (i.e. use of an EM field to transfer energy between two objects). The charging panel 608 provides received power to energy storage unit 612 by way of charging panel controller 610. Charging panel controller 610 is in communication with vehicle database 210, vehicle database 210 comprising an AV charging data structure.

Charging panel 508 may be located anywhere on vehicle 100, to include, for example, the roof, side panel, trunk, hood, front or rear bumper and wheel hub of vehicle 100. Charging panel 608 is mounted on the roof of vehicle 100 in the embodiment of FIG. 10. In some embodiments, charging panel 608 may be deployable, i.e. may extend or deploy only when charging is needed. For example, charging panel 608 may typically reside flush with the roof of vehicle 100 and extend when required for charging. Similarly, charger plate 520 may, in one embodiment, not be connected to AV 280 by way of tether 1010 and may instead be mounted directly on the AV 280, to include, for example, the wing, empennage, undercarriage to include landing gear, and may be deployable or extendable when required. Tether 1010 may be configured to maneuver charging plate 520 to any position on vehicle 100 so as to enable charging. In one embodiment, the AV 280 may land on the vehicle 100 so as to enable charging through direct contact (i.e. the aforementioned contact charging configuration) between the charging plate 520 and the charging panel 608 of vehicle 100. Charging may occur while both AV 280 and vehicle 100 are moving, while both vehicle 100 and AV 280 are not moving (i.e., vehicle 100 is parked and AV 280 lands on top of vehicle 100), or while vehicle 100 is parked and AV 280 is hovering or circling above. Control of the charging and/or positioning of the charging plate 520 may be manual, automatic or semi-automatic; said control may be performed through a GUI engaged by driver or occupant of receiving vehicle 100 and/or driver or occupant of charging AV 280.

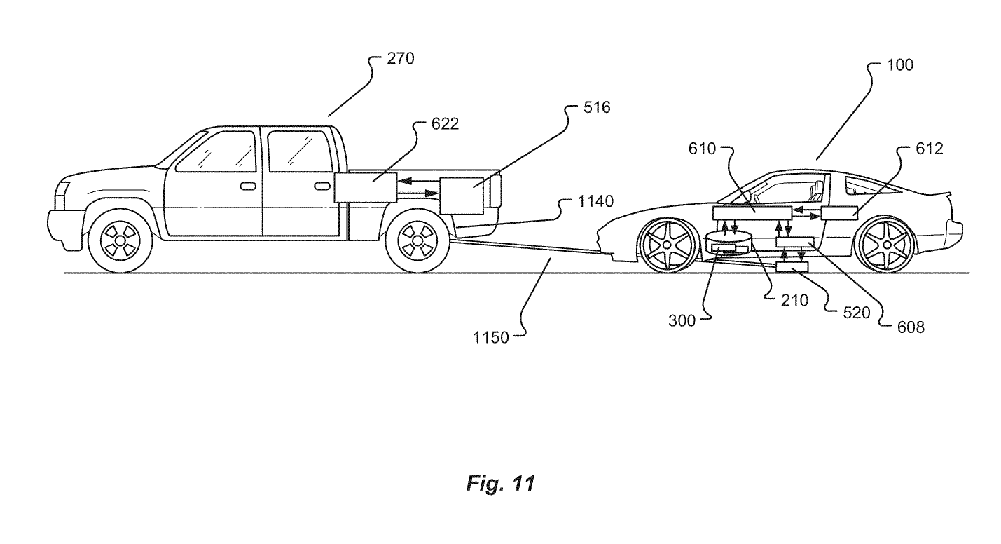

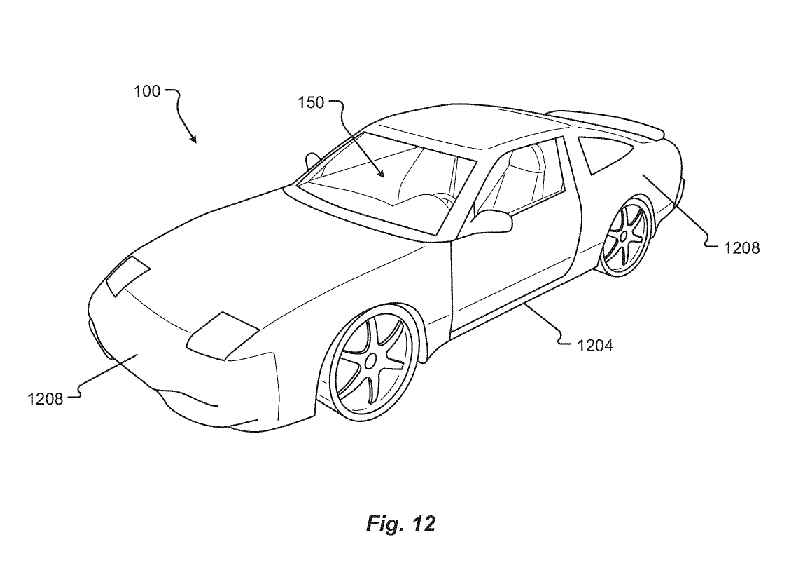

FIG. 11 is an embodiment of a vehicle emergency charging system comprising an emergency charging vehicle 270 and charge receiver vehicle 100 is disclosed. The emergency charging vehicle 270 is a road vehicle, such as a pick-up truck, as shown in FIG. 11. The emergency charging vehicle 270 is configured to provide a charge to a charge receiver vehicle 100, such as an automobile. The emergency charging vehicle 270 comprises an energy source i.e. a charging power source 516 and a charge provider controller 622 in communication with the charging power source 516. The emergency charging vehicle 270 provides a towed and/or articulated charger plate 520, as connected to the emergency charging vehicle 270 by connector 1150. The connector 1150 may comprise a chain, rope, rigid or semi-rigid tow bar or any means to position charger plate 520 near the charging panel 608 of vehicle 100. Charge or power output of charging power source 516 is provided or transmitted to charger plate 520 by way of charging cable or wire 1140. In one embodiment, the charging cable 1140 is non-structural, that is, it provides little or no structural support to the connection between emergency charging vehicle 270 and charging panel 608. Charging panel 608 (of vehicle 100) receives power from charger plate 520. Charger plate 520 and charging panel 608 may be in direct physical contact or not in direct physical contact, but must be at or below a threshold separation distance to enable charging, such as by induction. Charger plate 520 may comprise wheels or rollers so as to roll along roadway surface. Charger plate 520 may also not contact the ground surface and instead be suspended above the ground; such a configuration may be termed a “flying” configuration. In the flying configuration, charger plate may form an aerodynamic surface to, for example, facilitate stability and control of the positioning of the charging plate 520. Energy transfer or charging from the charger plate 520 to the charge receiver panel 608 is through inductive charging (i.e. use of an EM field to transfer energy between two objects). The charging panel 608 provides received power to energy storage unit 612 directly or by way of charging panel controller 610. In one embodiment, the receipt and/or control of the energy provided via the charging panel 608 is provided by charging panel controller 610.

Charging panel controller 610 may be located anywhere on charge receiver vehicle 100, to include, for example, the roof, side panel, trunk, hood, front or rear bumper and wheel hub of charge receiver 100 vehicle. In some embodiments, charging panel 608 may be deployable, i.e. may extend or deploy only when charging is needed. For example, charging panel 608 may typically stow flush with the lower plane of vehicle 100 and extend when required for charging. Similarly, charger plate 520 may, in one embodiment, not be connected to the lower rear of the emergency charging vehicle 270 by way of connector 1150 and may instead be mounted on the emergency charging vehicle 270, to include, for example, the roof, side panel, trunk, hood, front or rear bumper and wheel hub of emergency charging vehicle 270. Connector 1150 may be configured to maneuver connector plate 520 to any position on emergency charging vehicle 270 so as to enable charging. Control of the charging and/or positioning of the charging plate may be manual, automatic or semi-automatic; said control may be performed through a GUI engaged by driver or occupant of receiving vehicle and/or driver or occupant of charging vehicle.

FIG. 12 shows a perspective view of a vehicle 100 in accordance with embodiments of the present disclosure. Although shown in the form of a car, it should be appreciated that the vehicle 100 described herein may include any conveyance or model of a conveyance, where the conveyance was designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, busses, automobiles, trains, railed conveyances, boats, ships, marine conveyances, submarine conveyances, airplanes, space craft, flying machines, human-powered conveyances, and the like. In any event, the vehicle 100 may include a frame 1204 and one or more body panels 1208 mounted or affixed thereto. The vehicle 100 may include one or more interior components (e.g., components inside an interior space 150, or user space, of a vehicle 100, etc.), exterior components (e.g., components outside of the interior space 150, or user space, of a vehicle 100, etc.), drive systems, controls systems, structural components.

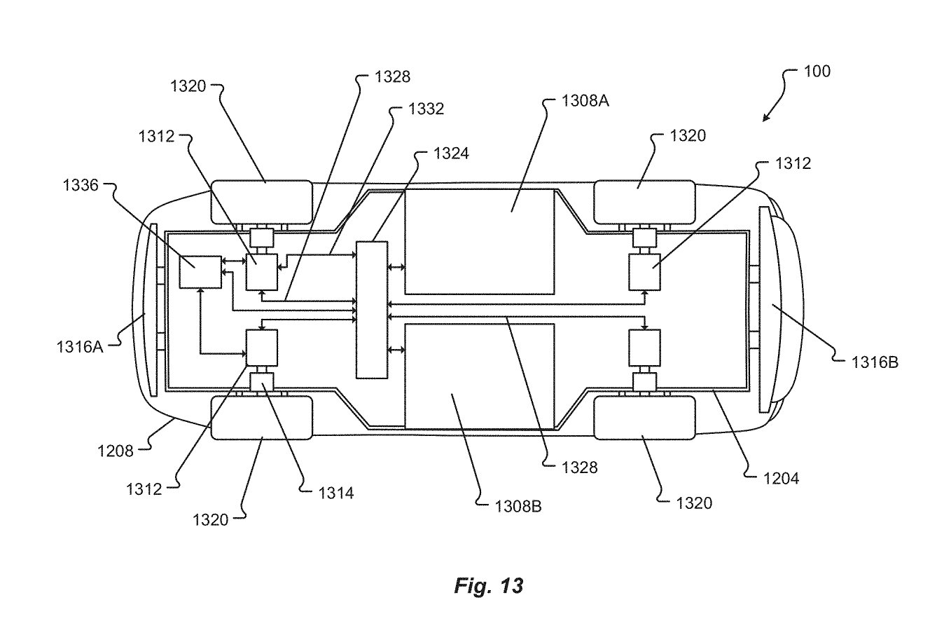

Referring now to FIG. 13, a plan view of a vehicle 100 will be described in accordance with embodiments of the present disclosure. As provided above, the vehicle 100 may comprise a number of electrical and/or mechanical systems, subsystems, etc. The mechanical systems of the vehicle 100 can include structural, power, safety, and communications subsystems, to name a few. While each subsystem may be described separately, it should be appreciated that the components of a particular subsystem may be shared between one or more other subsystems of the vehicle 100.

The structural subsystem includes the frame 1204 of the vehicle 100. The frame 1204 may comprise a separate frame and body construction (i.e., body-on-frame construction), a unitary frame and body construction (i.e., a unibody construction), or any other construction defining the structure of the vehicle 100. The frame 1204 may be made from one or more materials including, but in no way limited to steel, titanium, aluminum, carbon fiber, plastic, polymers, etc., and/or combinations thereof. In some embodiments, the frame 1204 may be formed, welded, fused, fastened, pressed, etc., combinations thereof, or otherwise shaped to define a physical structure and strength of the vehicle 100. In any event, the frame 1204 may comprise one or more surfaces, connections, protrusions, cavities, mounting points, tabs, slots, or other features that are configured to receive other components that make up the vehicle 100. For example, the body panels, powertrain subsystem, controls systems, interior components, communications subsystem, and safety subsystem may interconnect with, or attach to, the frame 1204 of the vehicle 100.

The frame 1204 may include one or more modular system and/or subsystem connection mechanisms. These mechanisms may include features that are configured to provide a selectively interchangeable interface for one or more of the systems and/or subsystems described herein. The mechanisms may provide for a quick exchange, or swapping, of components while providing enhanced security and adaptability over conventional manufacturing or attachment. For instance, the ability to selectively interchange systems and/or subsystems in the vehicle 100 allow the vehicle 100 to adapt to the ever-changing technological demands of society and advances in safety. Among other things, the mechanisms may provide for the quick exchange of batteries, capacitors, power sources 1308A, 1308B, motors 1312, engines, safety equipment, controllers, user interfaces, interiors exterior components, body panels 1208, bumpers 1316, sensors, etc., and/or combinations thereof. Additionally or alternatively, the mechanisms may provide unique security hardware and/or software embedded therein that, among other things, can prevent fraudulent or low quality construction replacements from being used in the vehicle 100. Similarly, the mechanisms, subsystems, and/or receiving features in the vehicle 100 may employ poka-yoke, or mistake-proofing, features that ensure a particular mechanism is always interconnected with the vehicle 100 in a correct position, function, etc.

By way of example, complete systems or subsystems may be removed and/or replaced from a vehicle 100 utilizing a single minute exchange principle. In some embodiments, the frame 1204 may include slides, receptacles, cavities, protrusions, and/or a number of other features that allow for quick exchange of system components. In one embodiment, the frame 1204 may include tray or ledge features, mechanical interconnection features, locking mechanisms, retaining mechanisms, etc., and/or combinations thereof. In some embodiments, it may be beneficial to quickly remove a used power source 1308A, 1308B (e.g., battery unit, capacitor unit, etc.) from the vehicle 100 and replace the used power source 1308A, 1308B with a charged power source. Continuing this example, the power source 1308A, 1308B may include selectively interchangeable features that interconnect with the frame 1204 or other portion of the vehicle 100. For instance, in a power source 1308A, 1308B replacement, the quick release features may be configured to release the power source 1308A, 1308B from an engaged position and slide or move away from the frame 1204 of a vehicle 100. Once removed, the power source 1308A, 1308B may be replaced (e.g., with a new power source, a charged power source, etc.) by engaging the replacement power source into a system receiving position adjacent to the vehicle 100. In some embodiments, the vehicle 100 may include one or more actuators configured to position, lift, slide, or otherwise engage the replacement power source with the vehicle 100. In one embodiment, the replacement power source may be inserted into the vehicle 100 or vehicle frame 1204 with mechanisms and/or machines that are external or separate from the vehicle 100.

In some embodiments, the frame 1204 may include one or more features configured to selectively interconnect with other vehicles and/or portions of vehicles. These selectively interconnecting features can allow for one or more vehicles to selectively couple together and decouple for a variety of purposes. For example, it is an aspect of the present disclosure that a number of vehicles may be selectively coupled together to share energy, increase power output, provide security, decrease power consumption, provide towing services, and/or provide a range of other benefits. Continuing this example, the vehicles may be coupled together based on travel route, destination, preferences, settings, sensor information, and/or some other data. The coupling may be initiated by at least one controller of the vehicle and/or traffic control system upon determining that a coupling is beneficial to one or more vehicles in a group of vehicles or a traffic system. As can be appreciated, the power consumption for a group of vehicles traveling in a same direction may be reduced or decreased by removing any aerodynamic separation between vehicles. In this case, the vehicles may be coupled together to subject only the foremost vehicle in the coupling to air and/or wind resistance during travel. In one embodiment, the power output by the group of vehicles may be proportionally or selectively controlled to provide a specific output from each of the one or more of the vehicles in the group.

The interconnecting, or coupling, features may be configured as electromagnetic mechanisms, mechanical couplings, electromechanical coupling mechanisms, etc., and/or combinations thereof. The features may be selectively deployed from a portion of the frame 1204 and/or body of the vehicle 100. In some cases, the features may be built into the frame 1204 and/or body of the vehicle 100. In any event, the features may deploy from an unexposed position to an exposed position or may be configured to selectively engage/disengage without requiring an exposure or deployment of the mechanism from the frame 1204 and/or body. In some embodiments, the interconnecting features may be configured to interconnect one or more of power, communications, electrical energy, fuel, and/or the like. One or more of the power, mechanical, and/or communications connections between vehicles may be part of a single interconnection mechanism. In some embodiments, the interconnection mechanism may include multiple connection mechanisms. In any event, the single interconnection mechanism or the interconnection mechanism may employ the poka-yoke features as described above.

The power system of the vehicle 100 may include the powertrain, power distribution system, accessory power system, and/or any other components that store power, provide power, convert power, and/or distribute power to one or more portions of the vehicle 100. The powertrain may include the one or more electric motors 1312 of the vehicle 100. The electric motors 1312 are configured to convert electrical energy provided by a power source into mechanical energy. This mechanical energy may be in the form of a rotational or other output force that is configured to propel or otherwise provide a motive force for the vehicle 100.

In some embodiments, the vehicle 100 may include one or more drive wheels 1320 that are driven by the one or more electric motors 1312 and motor controllers 1314. In some cases, the vehicle 100 may include an electric motor 1312 configured to provide a driving force for each drive wheel 1320. In other cases, a single electric motor 1312 may be configured to share an output force between two or more drive wheels 1320 via one or more power transmission components. It is an aspect of the present disclosure that the powertrain include one or more power transmission components, motor controllers 1314, and/or power controllers that can provide a controlled output of power to one or more of the drive wheels 1320 of the vehicle 100. The power transmission components, power controllers, or motor controllers 1314 may be controlled by at least one other vehicle controller described herein.

As provided above, the powertrain of the vehicle 100 may include one or more power sources 1308A, 1308B. These one or more power sources 1308A, 1308B may be configured to provide drive power, system and/or subsystem power, accessory power, etc. While described herein as a single power source 1308 for sake of clarity, embodiments of the present disclosure are not so limited. For example, it should be appreciated that independent, different, or separate power sources 1308A, 1308B may provide power to various systems of the vehicle 100. For instance, a drive power source may be configured to provide the power for the one or more electric motors 1312 of the vehicle 100, while a system power source may be configured to provide the power for one or more other systems and/or subsystems of the vehicle 100. Other power sources may include an accessory power source, a backup power source, a critical system power source, and/or other separate power sources. Separating the power sources 1308A, 1308B in this manner may provide a number of benefits over conventional vehicle systems. For example, separating the power sources 1308A, 1308B allow one power source 1308 to be removed and/or replaced independently without requiring that power be removed from all systems and/or subsystems of the vehicle 100 during a power source 1308 removal/replacement. For instance, one or more of the accessories, communications, safety equipment, and/or backup power systems, etc., may be maintained even when a particular power source 1308A, 1308B is depleted, removed, or becomes otherwise inoperable.

In some embodiments, the drive power source may be separated into two or more cells, units, sources, and/or systems. By way of example, a vehicle 100 may include a first drive power source 1308A and a second drive power source 1308B. The first drive power source 1308A may be operated independently from or in conjunction with the second drive power source 1308B and vice versa. Continuing this example, the first drive power source 1308A may be removed from a vehicle while a second drive power source 1308B can be maintained in the vehicle 100 to provide drive power. This approach allows the vehicle 100 to significantly reduce weight (e.g., of the first drive power source 1308A, etc.) and improve power consumption, even if only for a temporary period of time. In some cases, a vehicle 100 running low on power may automatically determine that pulling over to a rest area, emergency lane, and removing, or “dropping off,” at least one power source 1308A, 1308B may reduce enough weight of the vehicle 100 to allow the vehicle 100 to navigate to the closest power source replacement and/or charging area. In some embodiments, the removed, or “dropped off,” power source 1308A may be collected by a collection service, vehicle mechanic, tow truck, or even another vehicle or individual.

The power source 1308 may include a GPS or other geographical location system that may be configured to emit a location signal to one or more receiving entities. For instance, the signal may be broadcast or targeted to a specific receiving party. Additionally or alternatively, the power source 1308 may include a unique identifier that may be used to associate the power source 1308 with a particular vehicle 100 or vehicle user. This unique identifier may allow an efficient recovery of the power source 1308 dropped off. In some embodiments, the unique identifier may provide information for the particular vehicle 100 or vehicle user to be billed or charged with a cost of recovery for the power source 1308.

The power source 1308 may include a charge controller 1324 that may be configured to determine charge levels of the power source 1308, control a rate at which charge is drawn from the power source 1308, control a rate at which charge is added to the power source 1308, and/or monitor a health of the power source 1308 (e.g., one or more cells, portions, etc.). In some embodiments, the charge controller 1324 or the power source 1308 may include a communication interface. The communication interface can allow the charge controller 1324 to report a state of the power source 1308 to one or more other controllers of the vehicle 100 or even communicate with a communication device separate and/or apart from the vehicle 100. Additionally or alternatively, the communication interface may be configured to receive instructions (e.g., control instructions, charge instructions, communication instructions, etc.) from one or more other controllers of the vehicle 100 or a communication device that is separate and/or apart from the vehicle 100.

The powertrain includes one or more power distribution systems configured to transmit power from the power source 1308 to one or more electric motors 1312 in the vehicle 100. The power distribution system may include electrical interconnections 1328 in the form of cables, wires, traces, wireless power transmission systems, etc., and/or combinations thereof. It is an aspect of the present disclosure that the vehicle 100 include one or more redundant electrical interconnections 1332 of the power distribution system. The redundant electrical interconnections 1332 can allow power to be distributed to one or more systems and/or subsystems of the vehicle 100 even in the event of a failure of an electrical interconnection portion of the vehicle 100 (e.g., due to an accident, mishap, tampering, or other harm to a particular electrical interconnection, etc.). In some embodiments, a user of a vehicle 100 may be alerted via a user interface associated with the vehicle 100 that a redundant electrical interconnection 1332 is being used and/or damage has occurred to a particular area of the vehicle electrical system. In any event, the one or more redundant electrical interconnections 1332 may be configured along completely different routes than the electrical interconnections 1328 and/or include different modes of failure than the electrical interconnections 1328 to, among other things, prevent a total interruption power distribution in the event of a failure.

In some embodiments, the power distribution system may include an energy recovery system 1336. This energy recovery system 1336, or kinetic energy recovery system, may be configured to recover energy produced by the movement of a vehicle 100. The recovered energy may be stored as electrical and/or mechanical energy. For instance, as a vehicle 100 travels or moves, a certain amount of energy is required to accelerate, maintain a speed, stop, or slow the vehicle 100. In any event, a moving vehicle has a certain amount of kinetic energy. When brakes are applied in a typical moving vehicle, most of the kinetic energy of the vehicle is lost as the generation of heat in the braking mechanism. In an energy recovery system 1336, when a vehicle 100 brakes, at least a portion of the kinetic energy is converted into electrical and/or mechanical energy for storage. Mechanical energy may be stored as mechanical movement (e.g., in a flywheel, etc.) and electrical energy may be stored in batteries, capacitors, and/or some other electrical storage system. In some embodiments, electrical energy recovered may be stored in the power source 1308. For example, the recovered electrical energy may be used to charge the power source 1308 of the vehicle 100.

The vehicle 100 may include one or more safety systems. Vehicle safety systems can include a variety of mechanical and/or electrical components including, but in no way limited to, low impact or energy-absorbing bumpers 1316A, 1316B, crumple zones, reinforced body panels, reinforced frame components, impact bars, power source containment zones, safety glass, seatbelts, supplemental restraint systems, air bags, escape hatches, removable access panels, impact sensors, accelerometers, vision systems, radar systems, etc., and/or the like. In some embodiments, the one or more of the safety components may include a safety sensor or group of safety sensors associated with the one or more of the safety components. For example, a crumple zone may include one or more strain gages, impact sensors, pressure transducers, etc. These sensors may be configured to detect or determine whether a portion of the vehicle 100 has been subjected to a particular force, deformation, or other impact. Once detected, the information collected by the sensors may be transmitted or sent to one or more of a controller of the vehicle 100 (e.g., a safety controller, vehicle controller, etc.) or a communication device associated with the vehicle 100 (e.g., across a communication network, etc.).

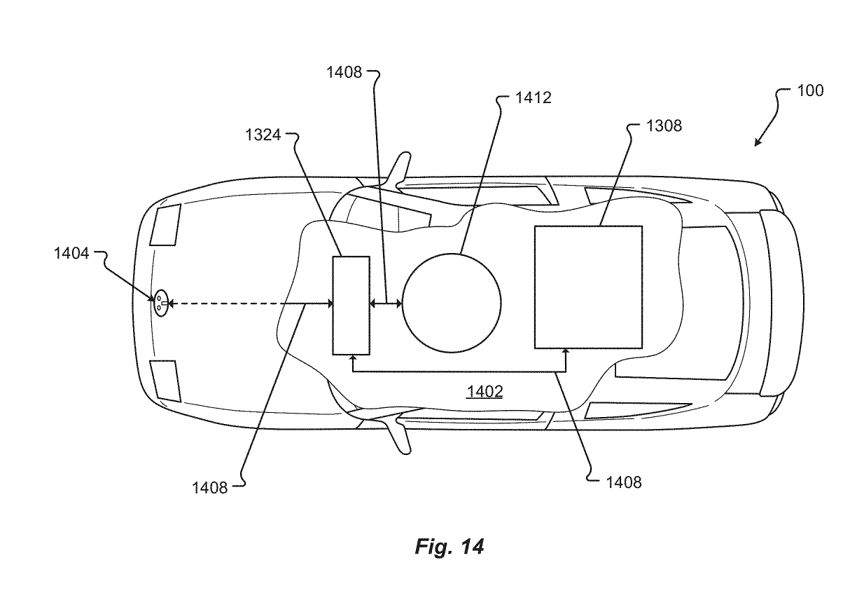

FIG. 14 shows a plan view of the vehicle 100 in accordance with embodiments of the present disclosure. In particular, FIG. 14 shows a broken section 1402 of a charging system for the vehicle 100. The charging system may include a plug or receptacle 1404 configured to receive power from an external power source (e.g., a source of power that is external to and/or separate from the vehicle 100, etc.). An example of an external power source may include the standard industrial, commercial, or residential power that is provided across power lines. Another example of an external power source may include a proprietary power system configured to provide power to the vehicle 100. In any event, power received at the plug/receptacle 1404 may be transferred via at least one power transmission interconnection 1408. Similar, if not identical, to the electrical interconnections 1328 described above, the at least one power transmission interconnection 1408 may be one or more cables, wires, traces, wireless power transmission systems, etc., and/or combinations thereof. Electrical energy in the form of charge can be transferred from the external power source to the charge controller 1324. As provided above, the charge controller 1324 may regulate the addition of charge to the power source 1308 of the vehicle 100 (e.g., until the power source 1308 is full or at a capacity, etc.).

In some embodiments, the vehicle 100 may include an inductive charging system and inductive charger 1412. The inductive charger 1412 may be configured to receive electrical energy from an inductive power source external to the vehicle 100. In one embodiment, when the vehicle 100 and/or the inductive charger 1412 is positioned over an inductive power source external to the vehicle 100, electrical energy can be transferred from the inductive power source to the vehicle 100. For example, the inductive charger 1412 may receive the charge and transfer the charge via at least one power transmission interconnection 1408 to the charge controller 1324 and/or the power source 1308 of the vehicle 100. The inductive charger 1412 may be concealed in a portion of the vehicle 100 (e.g., at least partially protected by the frame 1204, one or more body panels 1208, a shroud, a shield, a protective cover, etc., and/or combinations thereof) and/or may be deployed from the vehicle 100. In some embodiments, the inductive charger 1412 may be configured to receive charge only when the inductive charger 1412 is deployed from the vehicle 100. In other embodiments, the inductive charger 1412 may be configured to receive charge while concealed in the portion of the vehicle 100.

In addition to the mechanical components described herein, the vehicle 100 may include a number of user interface devices. The user interface devices receive and translate human input into a mechanical movement or electrical signal or stimulus. The human input may be one or more of motion (e.g., body movement, body part movement, in two-dimensional or three-dimensional space, etc.), voice, touch, and/or physical interaction with the components of the vehicle 100. In some embodiments, the human input may be configured to control one or more functions of the vehicle 100 and/or systems of the vehicle 100 described herein. User interfaces may include, but are in no way limited to, at least one graphical user interface of a display device, steering wheel or mechanism, transmission lever or button (e.g., including park, neutral, reverse, and/or drive positions, etc.), throttle control pedal or mechanism, brake control pedal or mechanism, power control switch, communications equipment, etc.

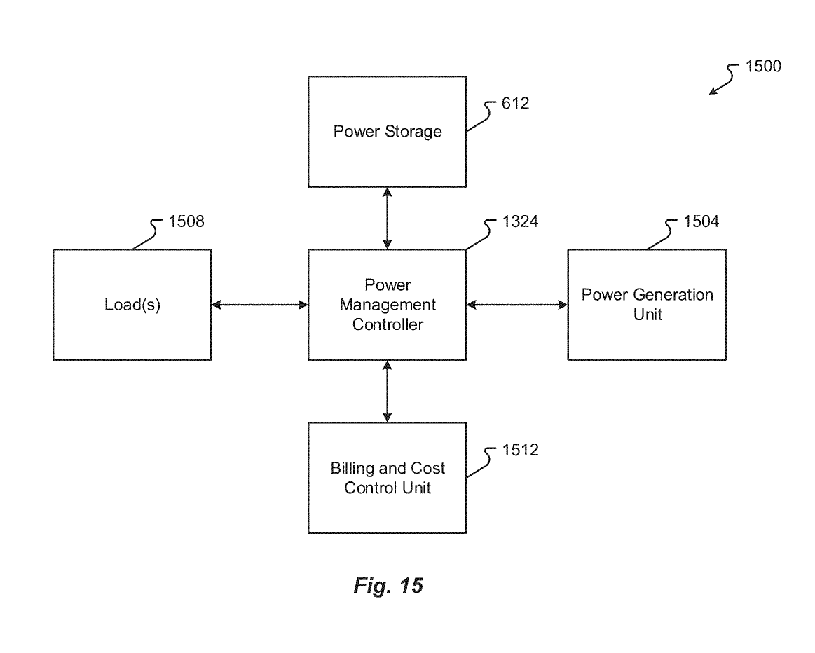

An embodiment of the electrical system 1500 associated with the vehicle 100 may be as shown in FIG. 15. The electrical system 1500 can include power source(s) that generate power, power storage that stores power, and/or load(s) that consume power. Power sources may be associated with a power generation unit 1504. Power storage may be associated with a power storage system 612. Loads may be associated with loads 1508. The electrical system 1500 may be managed by a power management controller 1324. Further, the electrical system 1500 can include one or more other interfaces or controllers, which can include the billing and cost control unit 1512.

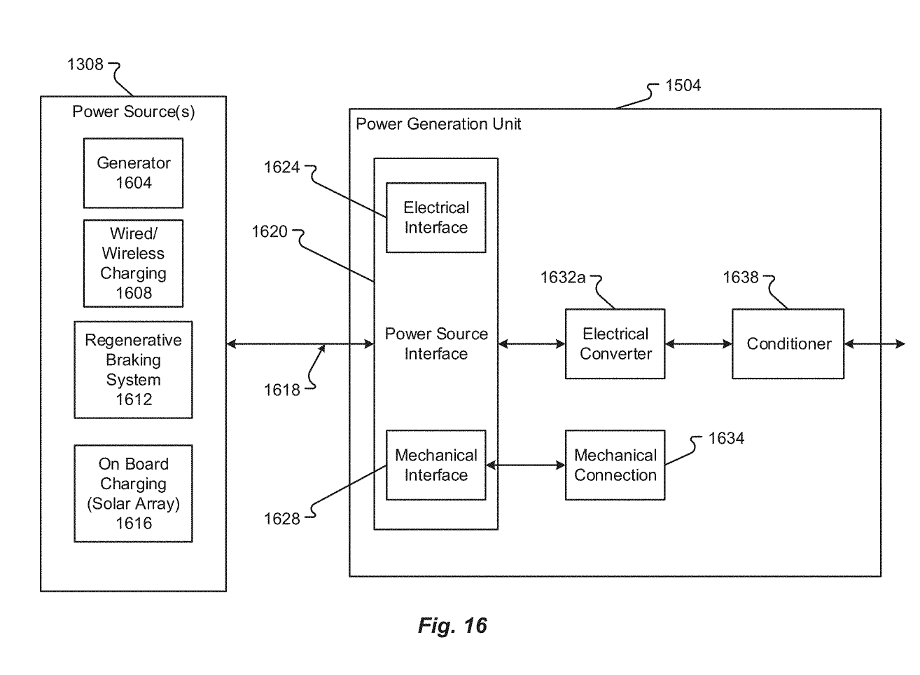

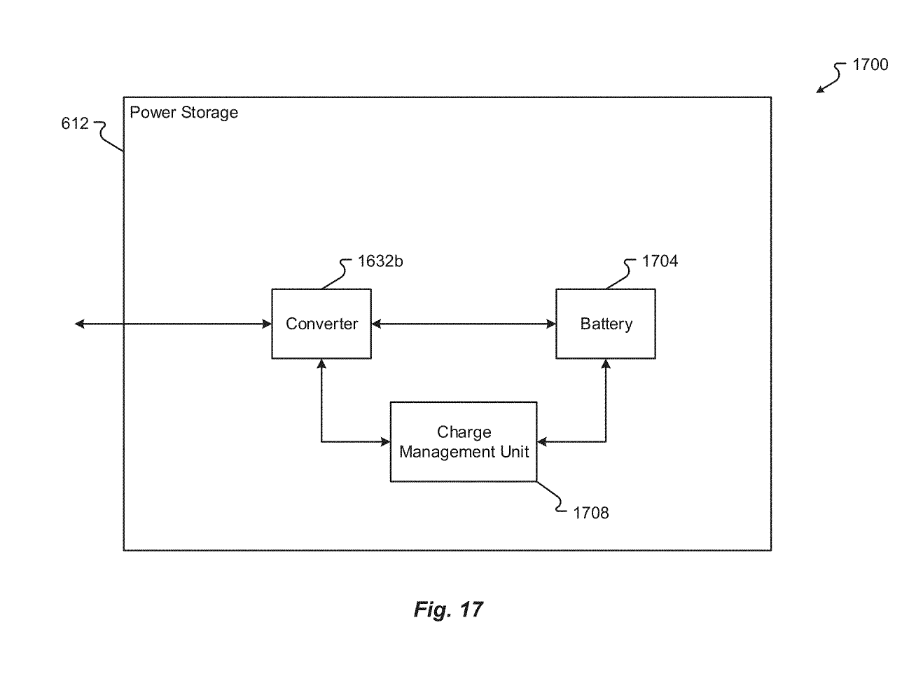

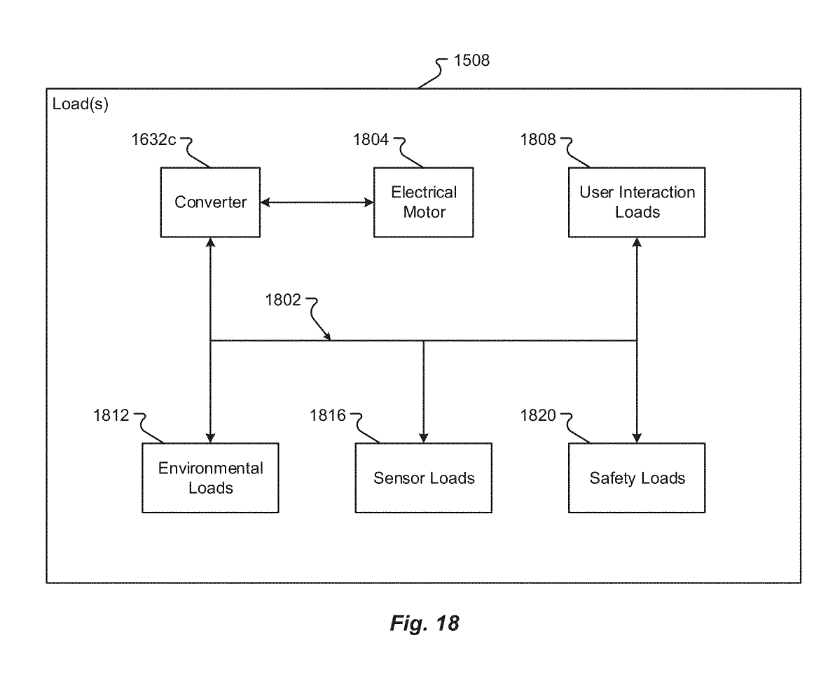

The power generation unit 1504 may be as described in conjunction with FIG. 16. The power storage component 612 may be as described in conjunction with FIG. 17. The loads 1508 may be as described in conjunction with FIG. 18.

The billing and cost control unit 1512 may interface with the power management controller 1324 to determine the amount of charge or power provided to the power storage 612 through the power generation unit 1504. The billing and cost control unit 1512 can then provide information for billing the vehicle owner. Thus, the billing and cost control unit 1512 can receive and/or send power information to third party system(s) regarding the received charge from an external source. The information provided can help determine an amount of money required, from the owner of the vehicle, as payment for the provided power. Alternatively, or in addition, if the owner of the vehicle provided power to another vehicle (or another device/system), that owner may be owed compensation for the provided power or energy, e.g., a credit.

The power management controller 1324 can be a computer or computing system(s) and/or electrical system with associated components, as described herein, capable of managing the power generation unit 1504 to receive power, routing the power to the power storage 612, and then providing the power from either the power generation unit 1504 and/or the power storage 612 to the loads 1508. Thus, the power management controller 1324 may execute programming that controls switches, devices, components, etc. involved in the reception, storage, and provision of the power in the electrical system 1500.

An embodiment of the power generation unit 1504 may be as shown in FIG. 16. Generally, the power generation unit 1504 may be electrically coupled to one or more power sources 1308. The power sources 1308 can include power sources internal and/or associated with the vehicle 100 and/or power sources external to the vehicle 100 to which the vehicle 100 electrically connects. One of the internal power sources can include an on board generator 1604. The generator 1604 may be an alternating current (AC) generator, a direct current (DC) generator or a self-excited generator. The AC generators can include induction generators, linear electric generators, and/or other types of generators. The DC generators can include homopolar generators and/or other types of generators. The generator 1604 can be brushless or include brush contacts and generate the electric field with permanent magnets or through induction. The generator 1604 may be mechanically coupled to a source of kinetic energy, such as an axle or some other power take-off. The generator 1604 may also have another mechanical coupling to an exterior source of kinetic energy, for example, a wind turbine.

Another power source 1308 may include wired or wireless charging 1608. The wireless charging system 1608 may include inductive and/or resonant frequency inductive charging systems that can include coils, frequency generators, controllers, etc. Wired charging may be any kind of grid-connected charging that has a physical connection, although, the wireless charging may be grid connected through a wireless interface. The wired charging system can include an connectors, wired interconnections, the controllers, etc. The wired and wireless charging systems 1608 can provide power to the power generation unit 1504 from external power sources 1308.

Internal sources for power may include a regenerative braking system 1612. The regenerative braking system 1612 can convert the kinetic energy of the moving car into electrical energy through a generation system mounted within the wheels, axle, and/or braking system of the vehicle 100. The regenerative braking system 1612 can include any coils, magnets, electrical interconnections, converters, controllers, etc. required to convert the kinetic energy into electrical energy.

Another source of power 1308, internal to or associated with the vehicle 100, may be a solar array 1616. The solar array 1616 may include any system or device of one or more solar cells mounted on the exterior of the vehicle 100 or integrated within the body panels of the vehicle 100 that provides or converts solar energy into electrical energy to provide to the power generation unit 1504.

The power sources 1308 may be connected to the power generation unit 1504 through an electrical interconnection 1618. The electrical interconnection 1618 can include any wire, interface, bus, etc. between the one or more power sources 1308 and the power generation unit 1504.

The power generation unit 1504 can also include a power source interface 1620. The power source interface 1620 can be any type of physical and/or electrical interface used to receive the electrical energy from the one or more power sources 1308; thus, the power source interface 1620 can include an electrical interface 1624 that receives the electrical energy and a mechanical interface 1628 which may include wires, connectors, or other types of devices or physical connections. The mechanical interface 1608 can also include a physical/electrical connection 1634 to the power generation unit 1504.

The electrical energy from the power source 1308 can be processed through the power source interface 1624 to an electric converter 1632. The electric converter 1632 may convert the characteristics of the power from one of the power sources into a useable form that may be used either by the power storage 612 or one or more loads 1508 within the vehicle 100. The electrical converter 1624 may include any electronics or electrical devices and/or component that can change electrical characteristics, e.g., AC frequency, amplitude, phase, etc. associated with the electrical energy provided by the power source 1308. The converted electrical energy may then be provided to an optional conditioner 1638. The conditioner 1638 may include any electronics or electrical devices and/or component that may further condition the converted electrical energy by removing harmonics, noise, etc. from the electrical energy to provide a more stable and effective form of power to the vehicle 100.

An embodiment of the power storage 1612 may be as shown in FIG. 17. The power storage unit can include an electrical converter 1632b, one or more batteries, one or more rechargeable batteries, one or more capacitors, one or more accumulators, one or more supercapacitors, one or more ultrabatteries, and/or superconducting magnetics 1704, and/or a charge management unit 1708. The converter 1632b may be the same or similar to the electrical converter 1632a shown in FIG. 16. The converter 1632b may be a replacement for the electric converter 1632a shown in FIG. 16 and thus eliminate the need for the electrical converter 1632a as shown in FIG. 16. However, if the electrical converter 1632a is provided in the power generation unit 1504, the converter 1632b, as shown in the power storage unit 612, may be eliminated. The converter 1632b can also be redundant or different from the electrical converter 1632a shown in FIG. 16 and may provide a different form of energy to the battery and/or capacitors 1704. Thus, the converter 1632b can change the energy characteristics specifically for the battery/capacitor 1704.

The battery 1704 can be any type of battery for storing electrical energy, for example, a lithium ion battery, a lead acid battery, a nickel cadmium battery, etc. Further, the battery 1704 may include different types of power storage systems, such as, ionic fluids or other types of fuel cell systems. The energy storage 1704 may also include one or more high-capacity capacitors 1704. The capacitors 1704 may be used for long-term or short-term storage of electrical energy. The input into the battery or capacitor 1704 may be different from the output, and thus, the capacitor 1704 may be charged quickly but drain slowly. The functioning of the converter 1632 and battery capacitor 1704 may be monitored or managed by a charge management unit 1708.

The charge management unit 1708 can include any hardware (e.g., any electronics or electrical devices and/or components), software, or firmware operable to adjust the operations of the converter 1632 or batteries/capacitors 1704. The charge management unit 1708 can receive inputs or periodically monitor the converter 1632 and/or battery/capacitor 1704 from this information; the charge management unit 1708 may then adjust settings or inputs into the converter 1632 or battery/capacitor 1704 to control the operation of the power storage system 612.

An embodiment of one or more loads 1508 associated with the vehicle 100 may be as shown in FIG. 18. The loads 1508 may include a bus or electrical interconnection system 1802, which provides electrical energy to one or more different loads within the vehicle 100. The bus 1802 can be any number of wires or interfaces used to connect the power generation unit 1504 and/or power storage 1612 to the one or more loads 1508. The converter 1632c may be an interface from the power generation unit 1504 or the power storage 612 into the loads 1508. The converter 1632c may be the same or similar to electric converter 1632a as shown in FIG. 16. Similar to the discussion of the converter 1632b in FIG. 17, the converter 1632c may be eliminated, if the electric converter 1632a, shown in FIG. 16, is present. However, the converter 1632c may further condition or change the energy characteristics for the bus 1802 for use by the loads 1508. The converter 1632c may also provide electrical energy to electric motor 1804, which may power the vehicle 100.

The electric motor 1804 can be any type of DC or AC electric motor. The electric motor may be a direct drive or induction motor using permanent magnets and/or winding either on the stator or rotor. The electric motor 1804 may also be wireless or include brush contacts. The electric motor 1804 may be capable of providing a torque and enough kinetic energy to move the vehicle 100 in traffic.

The different loads 1508 may also include environmental loads 1812, sensor loads 1816, safety loads 1820, user interaction loads 1808, etc. User interaction loads 1808 can be any energy used by user interfaces or systems that interact with the driver and/or passenger(s). These loads 1808 may include, for example, the heads up display, the dash display, the radio, user interfaces on the head unit, lights, radio, and/or other types of loads that provide or receive information from the occupants of the vehicle 100. The environmental loads 1812 can be any loads used to control the environment within the vehicle 100. For example, the air conditioning or heating unit of the vehicle 100 can be environmental loads 1812. Other environmental loads can include lights, fans, and/or defrosting units, etc. that may control the environment within the vehicle 100. The sensor loads 1816 can be any loads used by sensors, for example, air bag sensors, GPS, and other such sensors used to either manage or control the vehicle 100 and/or provide information or feedback to the vehicle occupants. The safety loads 1820 can include any safety equipment, for example, seat belt alarms, airbags, headlights, blinkers, etc. that may be used to manage the safety of the occupants. There may be more or fewer loads than those described herein, although they may not be shown in FIG. 18.

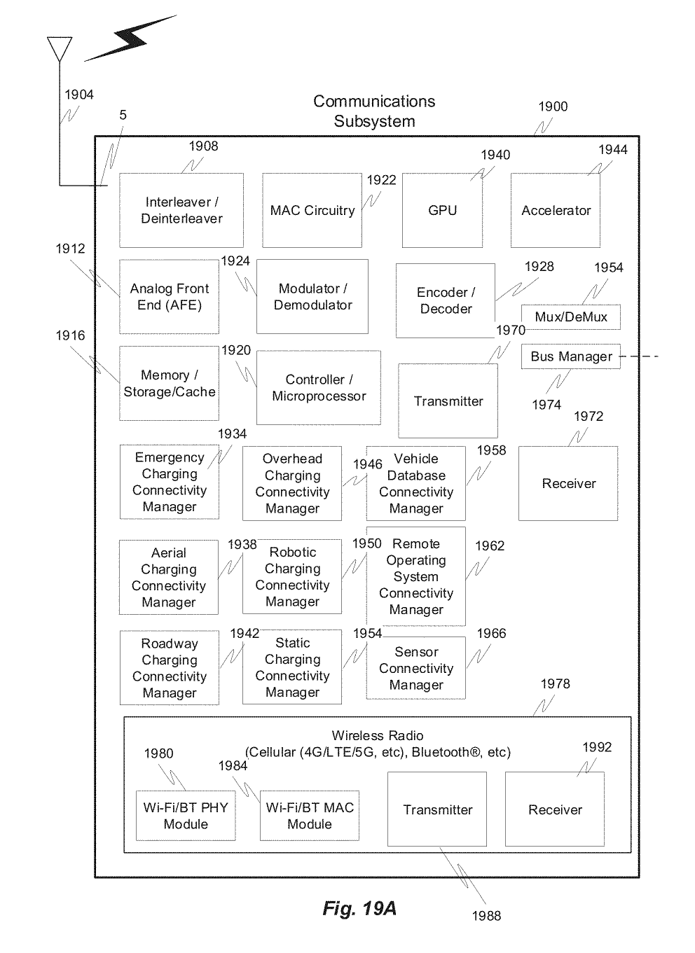

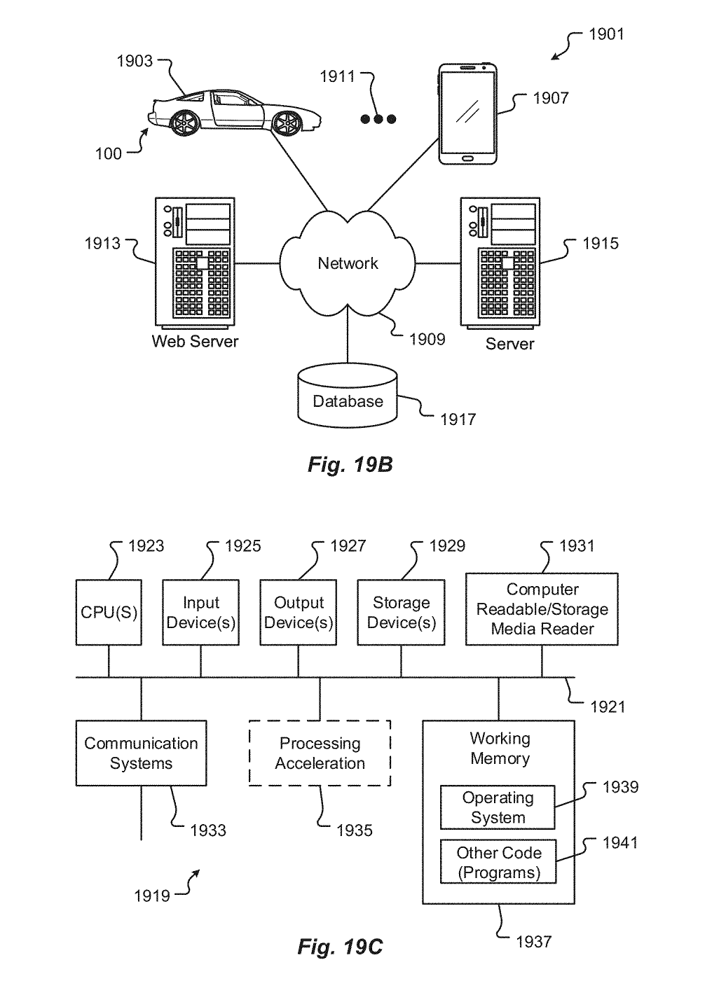

FIG. 19A illustrates an exemplary hardware diagram of communications componentry that can be optionally associated with the vehicle.

The communications componentry can include one or more wired or wireless devices such as a transceiver(s) and/or modem that allows communications not only between the various systems disclosed herein but also with other devices, such as devices on a network, and/or on a distributed network such as the Internet and/or in the cloud.

The communications subsystem can also include inter- and intra-vehicle communications capabilities such as hotspot and/or access point connectivity for any one or more of the vehicle occupants and/or vehicle-to-vehicle communications.

Additionally, and while not specifically illustrated, the communications subsystem can include one or more communications links (that can be wired or wireless) and/or communications busses (managed by the bus manager 1974), including one or more of CANbus, OBD-II, ARCINC 429, Byteflight, CAN (Controller Area Network), D2B (Domestic Digital Bus), FlexRay, DC-BUS, IDB-1394, IEBus, I²C, ISO 9141-1/-2, J1708, J1587, J1850, J1939, ISO 11783, Keyword Protocol 2000, LIN (Local Interconnect Network), MOST (Media Oriended Systems Transport), Multifunction Vehicle Bus, SMARTwireX, SPI, VAN (Vehicle Area Network), and the like or in general any communications protocol and/or standard.

The various protocols and communications can be communicated one or more of wirelessly and/or over transmission media such as single wire, twisted pair, fibre optic, IEEE 1394, MIL-STD-1553, MIL-STD-1773, power-line communication, or the like. (All of the above standards and protocols are incorporated herein by reference in their entirety)

As discussed, the communications subsystem enables communications between any if the inter-vehicle systems and subsystems as well as communications with non-collocated resources, such as those reachable over a network such as the Internet.

The communications subsystem, in addition to well-known componentry (which has been omitted for clarity), the device communications subsystem 1900 includes interconnected elements including one or more of: one or more antennas 1904, an interleaver/deinterleaver 1908, an analog front end (AFE) 1912, memory/storage/cache 1916, controller/microprocessor 1920, MAC circuitry 1922, modulator/demodulator 1924, encoder/decoder 1928, a plurality of connectivity managers 1934-1966, GPU 1940, accelerator 1944, a multiplexer/demultiplexer 1954, transmitter 1970, receiver 1972 and wireless radio 1978 components such as a Wi-Fi PHY/Bluetooth® module 1980, a Wi-Fi/BT MAC module 1984, transmitter 1988 and receiver 1992. The various elements in the device 1900 are connected by one or more links/busses 5 (not shown, again for sake of clarity).

The device 400 can have one more antennas 1904, for use in wireless communications such as multi-input multi-output (MIMO) communications, multi-user multi-input multi-output (MU-MIMO) communications Bluetooth®, LTE, 4G, 5G, Near-Field Communication (NFC), etc. The antenna(s) 1904 can include, but are not limited to one or more of directional antennas, omnidirectional antennas, monopoles, patch antennas, loop antennas, microstrip antennas, dipoles, and any other antenna(s) suitable for communication transmission/reception. In an exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users for example within the vehicle and/or in another vehicle.

Antenna(s) 1904 generally interact with the Analog Front End (AFE) 1912, which is needed to enable the correct processing of the received modulated signal and signal conditioning for a transmitted signal. The AFE 1912 can be functionally located between the antenna and a digital baseband system in order to convert the analog signal into a digital signal for processing and vice-versa.

The subsystem 1900 can also include a controller/microprocessor 1920 and a memory/storage/cache 1916. The subsystem 1900 can interact with the memory/storage/cache 1916 which may store information and operations necessary for configuring and transmitting or receiving the information described herein. The memory/storage/cache 1916 may also be used in connection with the execution of application programming or instructions by the controller/microprocessor 1920, and for temporary or long term storage of program instructions and/or data. As examples, the memory/storage/cache 1920 may comprise a computer-readable device, RAM, ROM, DRAM, SDRAM, and/or other storage device(s) and media.

The controller/microprocessor 1920 may comprise a general purpose programmable processor or controller for executing application programming or instructions related to the subsystem 1900. Furthermore, the controller/microprocessor 1920 can perform operations for configuring and transmitting/receiving information as described herein. The controller/microprocessor 1920 may include multiple processor cores, and/or implement multiple virtual processors. Optionally, the controller/microprocessor 1920 may include multiple physical processors. By way of example, the controller/microprocessor 1920 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The subsystem 1900 can further include a transmitter 1970 and receiver 1972 which can transmit and receive signals, respectively, to and from other devices, subsystems and/or other destinations using the one or more antennas 1904 and/or links/busses. Included in the subsystem 1900 circuitry is the medium access control or MAC Circuitry 1922. MAC circuitry 1922 provides for controlling access to the wireless medium. In an exemplary embodiment, the MAC circuitry 1922 may be arranged to contend for the wireless medium and configure frames or packets for communicating over the wireless medium.

The subsystem 1900 can also optionally contain a security module (not shown). This security module can contain information regarding but not limited to, security parameters required to connect the device to one or more other devices or other available network(s), and can include WEP or WPA/WPA-2 (optionally+AES and/or TKIP) security access keys, network keys, etc. The WEP security access key is a security password used by Wi-Fi networks. Knowledge of this code can enable a wireless device to exchange information with an access point and/or another device. The information exchange can occur through encoded messages with the WEP access code often being chosen by the network administrator. WPA is an added security standard that is also used in conjunction with network connectivity with stronger encryption than WEP.

The exemplary subsystem 1900 also includes a GPU 1940, an accelerator 1944, a Wi-Fi/BT/BLE PHY module 1980 and a Wi-Fi/BT/BLE MAC module 1984 and wireless transmitter 1988 and receiver 1992. In some embodiments, the GPU 1940 may be a graphics processing unit, or visual processing unit, comprising at least one circuit and/or chip that manipulates and changes memory to accelerate the creation of images in a frame buffer for output to at least one display device. The GPU 1940 may include one or more of a display device connection port, printed circuit board (PCB), a GPU chip, a metal-oxide-semiconductor field-effect transistor (MOSFET), memory (e.g., single data rate random-access memory (SDRAM), double data rate random-access memory (DDR) RAM, etc., and/or combinations thereof), a secondary processing chip (e.g., handling video out capabilities, processing, and/or other functions in addition to the GPU chip, etc.), a capacitor, heatsink, temperature control or cooling fan, motherboard connection, shielding, and the like.

The various connectivity managers 1934-1966 (even) manage and/or coordinate communications between the subsystem 1900 and one or more of the systems disclosed herein and one or more other devices/systems. The connectivity managers include an emergency charging connectivity manager 1934, an aerial charging connectivity manager 1938, a roadway charging connectivity manager 1942, an overhead charging connectivity manager 1946, a robotic charging connectivity manager 1950, a static charging connectivity manager 1954, a vehicle database connectivity manager 1958, a remote operating system connectivity manager 1962 and a sensor connectivity manager 1966.

The emergency charging connectivity manager 1934 can coordinate not only the physical connectivity between the vehicle and the emergency charging device/vehicle, but can also communicate with one or more of the power management controller, one or more third parties and optionally a billing system(s). As an example, the vehicle can establish communications with the emergency charging device/vehicle to one or more of coordinate interconnectivity between the two (e.g., by spatially aligning the charging receptacle on the vehicle with the charger on the emergency charging vehicle) and optionally share navigation information. Once charging is complete, the amount of charge provided can be tracked and optionally forwarded to, for example, a third party for billing. In addition to being able to manage connectivity for the exchange of power, the emergency charging connectivity manager 1934 can also communicate information, such as billing information to the emergency charging vehicle and/or a third party. This billing information could be, for example, the owner of the vehicle, the driver of the vehicle, company information, or in general any information usable to charge the appropriate entity for the power received.

The aerial charging connectivity manager 1938 can coordinate not only the physical connectivity between the vehicle and the aerial charging device/vehicle, but can also communicate with one or more of the power management controller, one or more third parties and optionally a billing system(s). As an example, the vehicle can establish communications with the aerial charging device/vehicle to one or more of coordinate interconnectivity between the two (e.g., by spatially aligning the charging receptacle on the vehicle with the charger on the emergency charging vehicle) and optionally share navigation information. Once charging is complete, the amount of charge provided can be tracked and optionally forwarded to, for example, a third party for billing. In addition to being able to manage connectivity for the exchange of power, the aerial charging connectivity manager 1938 can similarly communicate information, such as billing information to the aerial charging vehicle and/or a third party. This billing information could be, for example, the owner of the vehicle, the driver of the vehicle, company information, or in general any information usable to charge the appropriate entity for the power received etc., as discussed.

The roadway charging connectivity manager 1942 and overhead charging connectivity manager 1946 can coordinate not only the physical connectivity between the vehicle and the charging device/system, but can also communicate with one or more of the power management controller, one or more third parties and optionally a billing system(s). As one example, the vehicle can request a charge from the charging system when, for example, the vehicle needs or is predicted to need power. As an example, the vehicle can establish communications with the charging device/vehicle to one or more of coordinate interconnectivity between the two for charging and share information for billing. Once charging is complete, the amount of charge provided can be tracked and optionally forwarded to, for example, a third party for billing. This billing information could be, for example, the owner of the vehicle, the driver of the vehicle, company information, or in general any information usable to charge the appropriate entity for the power received etc., as discussed. The person responsible for paying for the charge could also receive a copy of the billing information as is customary. The robotic charging connectivity manager 1950 and static charging connectivity manager 1954 can operate in a similar manner to that described herein.

The vehicle database connectivity manager 1958 allows the subsystem to receive and/or share information stored in the vehicle database. This information can be shared with other vehicle components/subsystems and/or other entities, such as third parties and/or charging systems. The information can also be shared with one or more vehicle occupant devices, such as an app on a mobile device the driver uses to track information about the vehicle and/or a dealer or service/maintenance provider. In general any information stored in the vehicle database can optionally be shared with any one or more other devices optionally subject to any privacy or confidentially restrictions.

The remote operating system connectivity manager 1962 facilitates communications between the vehicle and any one or more autonomous vehicle systems. These communications can include one or more of navigation information, vehicle information, occupant information, or in general any information related to the remote operation of the vehicle.

The sensor connectivity manager 1966 facilitates communications between any one or more of the vehicle sensors and any one or more of the other vehicle systems. The sensor connectivity manager 1966 can also facilitate communications between any one or more of the sensors and/or vehicle systems and any other destination, such as a service company, app, or in general to any destination where sensor data is needed.

In accordance with one exemplary embodiment, any of the communications discussed herein can be communicated via the conductor(s) used for charging. One exemplary protocol usable for these communications is Power-line communication (PLC). PLC is a communication protocol that uses electrical wiring to simultaneously carry both data, and Alternating Current (AC) electric power transmission or electric power distribution. It is also known as power-line carrier, power-line digital subscriber line (PDSL), mains communication, power-line telecommunications, or power-line networking (PLN). For DC environments in vehicles PLC can be used in conjunction with CAN-bus, LIN-bus over power line (DC-LIN) and DC-BUS.

The communications subsystem can also optionally manage one or more identifiers, such as an IP (internet protocol) address(es), associated with the vehicle and one or other system or subsystems or components therein. These identifiers can be used in conjunction with any one or more of the connectivity managers as discussed herein.

FIG. 19B illustrates a block diagram of a computing environment 1901 that may function as the servers, user computers, or other systems provided and described above. The environment 1901 includes one or more user computers, or computing devices, such as a vehicle computing device 1903, a communication device 1907, and/or more 1911. The computing devices 1903, 1907, 1911 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 1903, 1907, 1911 may also have any of a variety of applications, including for example, database client and/or server applications, and web browser applications. Alternatively, the computing devices 1903, 1907, 1911 may be any other electronic device, such as a thin-client computer, Internet-enabled mobile telephone, and/or personal digital assistant, capable of communicating via a network 1909 and/or displaying and navigating web pages or other types of electronic documents. Although the exemplary computer environment 1901 is shown with two computing devices, any number of user computers or computing devices may be supported.

Environment 1901 further includes a network 1909. The network 1909 may can be any type of network familiar to those skilled in the art that can support data communications using any of a variety of commercially-available protocols, including without limitation SIP, TCP/IP, SNA, IPX, AppleTalk, and the like. Merely by way of example, the network 1909 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 1913, 1915. In this example, server 1913 is shown as a web server and server 1915 is shown as an application server. The web server 1913, which may be used to process requests for web pages or other electronic documents from computing devices 1903, 1907, 1911. The web server 1913 can be running an operating system including any of those discussed above, as well as any commercially-available server operating systems. The web server 1913 can also run a variety of server applications, including SIP servers, HTTP servers, FTP servers, CGI servers, database servers, Java servers, and the like. In some instances, the web server 1913 may publish operations available operations as one or more web services.

The environment 1901 may also include one or more file and or/application servers 1915, which can, in addition to an operating system, include one or more applications accessible by a client running on one or more of the computing devices 1903, 1907, 1911. The server(s) 1915 and/or 1913 may be one or more general purpose computers capable of executing programs or scripts in response to the computing devices 1903, 1907, 1911. As one example, the server 1915, 1913 may execute one or more web applications. The web application may be implemented as one or more scripts or programs written in any programming language, such as Java™, C, C#®, or C++, and/or any scripting language, such as Perl, Python, or TCL, as well as combinations of any programming/scripting languages. The application server(s) 1915 may also include database servers, including without limitation those commercially available from Oracle, Microsoft, Sybase™, IBM™ and the like, which can process requests from database clients running on a computing device 1903, 1907, 1911.

The web pages created by the server 1913 and/or 1915 may be forwarded to a computing device 1903, 1907, 1911 via a web (file) server 1913, 1915. Similarly, the web server 1913 may be able to receive web page requests, web services invocations, and/or input data from a computing device 1903, 1907, 1911 (e.g., a user computer, etc.) and can forward the web page requests and/or input data to the web (application) server 1915. In further embodiments, the server 1915 may function as a file server. Although for ease of description, FIG. 19B illustrates a separate web server 1913 and file/application server 1915, those skilled in the art will recognize that the functions described with respect to servers 1913, 1915 may be performed by a single server and/or a plurality of specialized servers, depending on implementation-specific needs and parameters. The computer systems 1903, 1907, 1911, web (file) server 1913 and/or web (application) server 1915 may function as the system, devices, or components described in FIGS. 1-19A.

The environment 1901 may also include a database 1917. The database 1917 may reside in a variety of locations. By way of example, database 1917 may reside on a storage medium local to (and/or resident in) one or more of the computers 1903, 1907, 1911, 1913, 1915. Alternatively, it may be remote from any or all of the computers 1903, 1907, 1911, 1913, 1915, and in communication (e.g., via the network 1909) with one or more of these. The database 1917 may reside in a storage-area network (“SAN”) familiar to those skilled in the art. Similarly, any necessary files for performing the functions attributed to the computers 1903, 1907, 1911, 1913, 1915 may be stored locally on the respective computer and/or remotely, as appropriate. The database 1917 may be a relational database, such as Oracle 20I®, that is adapted to store, update, and retrieve data in response to SQL-formatted commands.

FIG. 19C illustrates one embodiment of a computer system 1919 upon which the servers, user computers, computing devices, or other systems or components described above may be deployed or executed. The computer system 1919 is shown comprising hardware elements that may be electrically coupled via a bus 1921. The hardware elements may include one or more central processing units (CPUs) 1923; one or more input devices 1925 (e.g., a mouse, a keyboard, etc.); and one or more output devices 1927 (e.g., a display device, a printer, etc.). The computer system 1919 may also include one or more storage devices 1929. By way of example, storage device(s) 1929 may be disk drives, optical storage devices, solid-state storage devices such as a random access memory (“RAM”) and/or a read-only memory (“ROM”), which can be programmable, flash-updateable and/or the like.

The computer system 1919 may additionally include a computer-readable storage media reader 1931; a communications system 1933 (e.g., a modem, a network card (wireless or wired), an infra-red communication device, etc.); and working memory 1937, which may include RAM and ROM devices as described above. The computer system 1919 may also include a processing acceleration unit 1935, which can include a DSP, a special-purpose processor, and/or the like.

The computer-readable storage media reader 1931 can further be connected to a computer-readable storage medium, together (and, optionally, in combination with storage device(s) 1929) comprehensively representing remote, local, fixed, and/or removable storage devices plus storage media for temporarily and/or more permanently containing computer-readable information. The communications system 1933 may permit data to be exchanged with a network and/or any other computer described above with respect to the computer environments described herein. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 1919 may also comprise software elements, shown as being currently located within a working memory 1937, including an operating system 1939 and/or other code 1941. It should be appreciated that alternate embodiments of a computer system 1919 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 1923 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

The computer system 1919 and/or a remotely located web server 1913 or server 1915 can configure, determine or calculate a route of travel, or trace route, based, at least in part on a level of stored energy in the power storage 612 to ensure that the vehicle 120 will have sufficient energy to arrive at the waypoint or final destination. The route configuration, determination or selection can consider not only the level of stored energy but other factors, including location of a charging facility or station (e.g., a manual charging station 310J, robotic charging station 310K, roadway charging system 310L, emergency charging system 310M or 310N, and/or overhead charging system 258), power consumption over the route, power regeneration over the route, and other factors as set forth below.

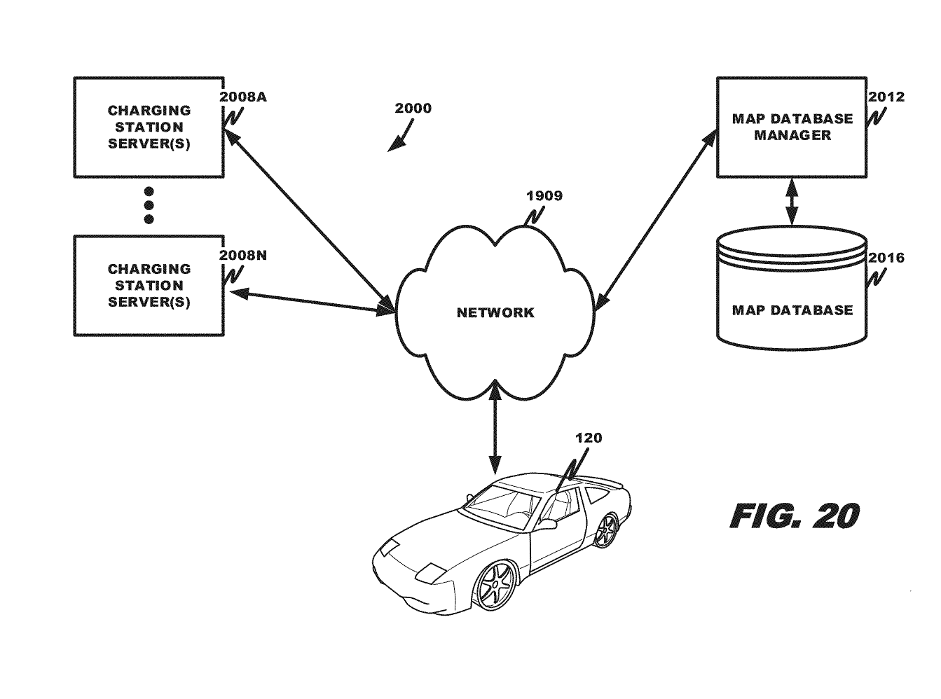

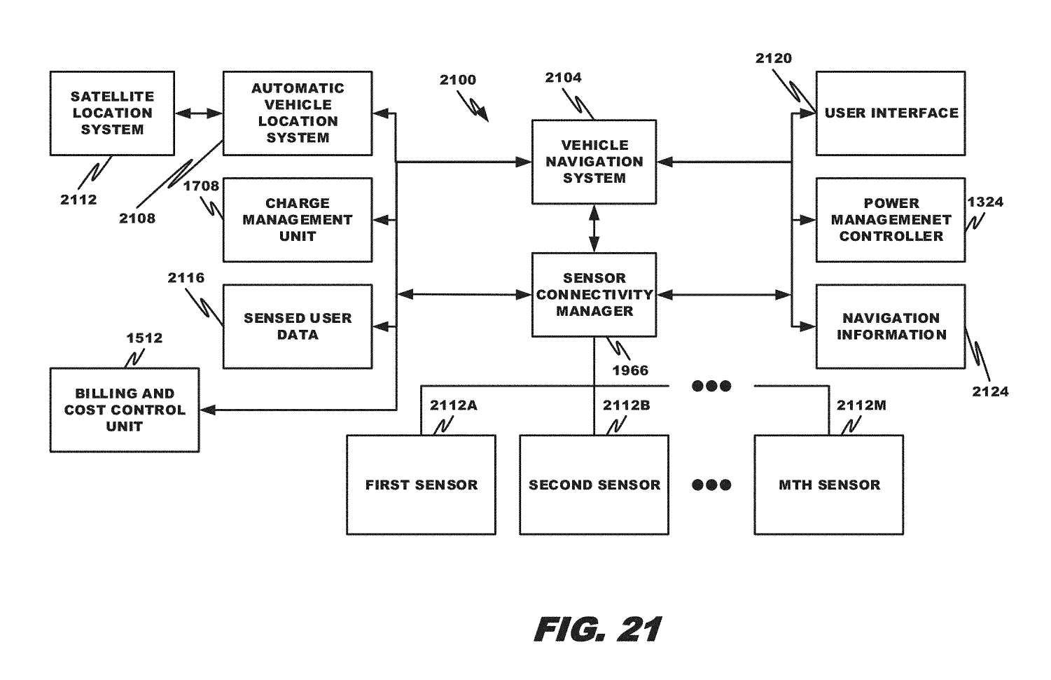

With reference to FIG. 20, the vehicle 120 is in wireless communication, via network 1909, with one or more charging station server(s) 2008A-N, a map database manager 2012 and associated map database 2016.

The charging station server(s) 2008A-N are each associated with a corresponding charging facility or station and communicate with both the vehicle 120 and map database manager 2012 regarding information related to the respective charging facility or station. For example, the charging station server 2008 can provide to the vehicle 120 and/or map database manager 2012 information related to the respective facility or station, such as available times for reservations to receive a charge from the respective facility or station, charging type 310A of the respective facility or station, operational data associated with the respective charging type, compatible vehicle charging panel types 310B, compatible vehicle storage units 310C, available automation level 310D, charging status 310E, charge rate 310F, cost 310G, shielding data element 310I, other data element(s) 310H, and further data fields 310P and 310Q, such as geographical location of the respective facility or station, hours of operation, current actual, expected or average vehicle waiting time for a charge, and the like.

The map database manager 2012 and map database 2016 interact with an automatic vehicle location system 2108 (discussed below) in the vehicle 120 to provide navigation or map output to the vehicle occupants.

The map database manager 2012 stores and recalls spatial map information from the map database 2016.

The map database 2016 contains plural maps. Maps are commonly stored as graphs, or two or three dimensional arrays of objects with attributes of location and category, where some common categories include parks, roads, cities, and the like. A map database commonly represents a road network along with associated features, with the road network corresponding to a selected road network model. Commonly, such a model comprises basic elements (nodes, links and areas) of the road network and properties of those elements (location coordinates, shape, addresses, road class, speed range, etc.). The basic elements are referred to as features and the properties as attributes. Other information associated with the road network can also be included, such as points of interest, waypoints, building shapes, and political boundaries. Geographic Data Files (GDF) is a standardized description of such a model. Each node within a map graph represents a point location of the surface of the Earth and can be represented by a pair of longitude (lon) and latitude (lat) coordinates. Each link can represent a stretch of road between two nodes, and be represented by a line segment (corresponding to a straight section of road) or a curve having a shape that is generally described by intermediate points (called shape points) along the link. However, curves can also be represented by a combination of centroid (point or node), with a radius, and polar coordinates to define the boundaries of the curve. Shape points can be represented by longitude and latitude coordinates as are nodes, but shape points generally do not serve the purpose of connecting links, as do nodes. Areas are generally two- or three-dimensional shapes that represent things like parks, cities, blocks and are defined by their boundaries (usually formed by a closed polygon).

Auxiliary data can be attached to the features and/or attributes. Various navigational functions, involving active safety, driver assistance and location-based services require data that is not considered to be part of a map database and is likely supplied by a vendor (such as the charging station servers 2008A-N) other than that of the map database manager 2012. This data (such as any of the data structures: available times for reservations to receive a charge from the respective facility or station, charging type 310A of the respective facility or station, operational data associated with the respective charging type, compatible vehicle charging panel types 310B, compatible vehicle storage units 310C, available automation level 310D, charging status 310E, charge rate 310F, cost 310G, shielding data element 310I, other data element(s) 310H, and further data fields 310P and 310Q, such as geographical location of the respective facility or station, hours of operation, current actual, expected or average vehicle waiting time for a charge, and the like), should be cross-referenced with the entities and attributes of the main map database 2016.

Since the auxiliary data is not necessarily compiled with the main map database some other means is generally needed to establish cross-referencing, which is referred to as attaching the auxiliary data. The common approaches are function-specific referencing tables and generic referencing.

Function-specific referencing tables provide a technique for attaching function-specific data to a map-data base produced by any participating vendor. Such a table can be collaboratively produced to support a specific function or class of functions involving location-based service, active-safety or advanced driver assistance. It will generally include a list of map elements of a specific type (e.g., links, intersections, point-of-interest locations, etc.) along with identifying attributes (e.g., street names, longitude/latitude coordinates, etc.). Additionally, each entry in the table can be assigned a unique identifier. The set of entries in a table are generally selected, through consensus of all interested parties. As a practical matter, the result will represent a small subset of the elements of the given type that are available in the map databases and will include those that are more important to the application area. After a table is formulated, it is generally the task of each participating vendor to determine and cross-reference the elements in their map-database that correspond to the table entries.

Generic referencing attaches data to any map database by discovering reference information through a form of map matching. The function-specific data items can be assigned to elements, such as points, links or areas, that likely only approximate the corresponding map elements in a specific map database. A search of the map database can be made for the best fit. To enhance the search process, neighboring elements can be strategically appended to each given element to help ensure that the correct solution is found in each case. For example, if the map element is a link connecting two intersections, then one or both cross streets could be appended for the sake of the search thereby making an incorrect match unlikely.

By way of illustration, the Navigation Data Standard (NDS) is a standardized format for automotive-grade navigation databases. NDS uses the SQLLite Database File Format. An NDS database can have several product databases, and each product database may be divided further into update regions. This concept supports a flexible and consistent versioning concept for NDS databases and makes it possible to integrate databases from different database suppliers into one NDS database. The inner structure of databases complying with Navigation Data Standard is further characterized by building blocks, levels and the content itself. An update region represents a geographic area in a database that can be subject to an update. All navigation data in an NDS database belongs a specific building block. Each building block addresses specific functional aspects of navigation, such as names for location input, routing, or map display.

With reference to FIG. 21, an on board navigation system 2100 in the vehicle 120 is depicted. The navigation system 2100 includes a vehicle navigation system 2104 in communication with an automatic vehicle location system 2108 and associated satellite location system 2112, charge management unit 1708, user data 2116, billing and cost control unit 1512, sensor connectivity manager 1966 and associated first, second, . . . mth sensors 2112A-M, user interface 2120, power management controller 1324, and navigation information 2124.

The vehicle navigation system 2104, based on received inputs from the automatic vehicle location system 2108, charge management unit 1708, sensed user data 2116, sensor connectivity manager 1966, user interface 2120, power management controller 1324, and navigation information 2124 received from the map database manager 2012, selects one or more proposed routes of travel of the vehicle 120 and provides the selected proposed routes to an occupant, such as a driver, via the user interface 2120. The occupant selects the route, which is then updated by the vehicle navigation system 2104 as the vehicle 120 travels towards the waypoint or destination. On the fly traffic information can be used to adjust the route.

The automatic vehicle location system 2108 is in communication with the satellite location system 2112 (such as a Global Positioning System (or Naystar GPS) or GPS transmitter) to acquire current vehicle position coordinates, which position coordinates are then correlated by the vehicle navigation system 2104 or the map database manager 2012 to a position on a road. Dead reckoning using distance data from one or more sensors 2112 attached to the drive train, a gyroscope sensor 2112 and/or an accelerometer sensor 2112 can be used for greater reliability, as GPS signal loss and/or multipath can occur due to vehicle navigation system 2104 and/or map database manager 2012 or tunnels. As will be appreciated, a GPS satellite location system or GPS receiver, and when used for vehicle navigation commonly referred to simply as a GPS, is a device that is capable of receiving information from GPS satellites (not shown) and then to accurately calculate the GPS location system's geographical location. The GPS navigation device or GPS receiver can be on board the vehicle 120, on a portable computational or communication device of an occupant (such as a smart phone, tablet computer, personal navigation assistant, or laptop PC), As will be appreciated, any other satellite location or navigation system can be employed, such as GLONASS, DeiDou Navigation Satellite System, Gallileo, GAGAN, IRNSS, and the like.

The charge management unit 1708 or power management controller 1324 provide to the vehicle navigation system electrical storage unit 612 or battery pack state information, such as battery classification for the battery pack, C- and E-rates for the battery pack, stored energy capacity or nominal capacity, energy or nominal energy (Wh for a specific C-rate), cycle life (number for a specific DOD), specific energy, specific power, energy density, power density, maximum continuous discharge current, maximum 30-second discharge pulse current, charge voltage, float voltage, (recommended) charge current, (maximum) internal resistance, terminal voltage, open-circuit voltage, internal resistance, nominal voltage, cut-off voltage, winding temperature, rotor speed, battery pack voltage level, output electrical current, electrical current direction of flow, leakage current, battery pack temperature, depth-of-charge, state-of-charge, or state-of-health, or state-of-function. This battery pack state information can be used by the vehicle navigation system 2104 or map database manager 2012 to locate along each possible route provided to the occupant charging locations along with related features and attributes.

The sensed user data 2116 is user or occupant behavior and state information sensed by the on board computer in the vehicle 120, such as current or historical user driving behavior, historical user route preferences, user identities, and the like. This information can be sensed by the first, second, . . . Mth sensor 2112A-M. This information can be used by the vehicle navigation system 2104 or map database manager 2012 to configure, determine or select (e.g., filter) a subset of possible routes for presentation to the user.

The first, second, . . . mth sensors 2112a-m can include a throttle or accelerator pedal position sensor, a brake pedal position sensor, manifold pressure sensor, engine coolant temperature sensor, mass air flow sensor, camshaft position sensor, crankshaft position sensor, pedal angle sensor, chassis position sensor, oxygen sensor, AC or DC current sensor, brake pad wear sensor, detonation sensor, EGR sensor, intake air temperature sensor, camera images captured of interior or exterior objects (such as occupants, roadways, roadside signals, and the like), seat belt settings, seat weight sensor, and the like. The sensor output provided, by the sensor connectivity manager 1966, to the vehicle navigation system 2104, charge management unit 1708 or power management controller 1324, as appropriate, can be, for instance, an operating metric or other parameter associated with the vehicle, such as vehicle speed, acceleration, rotor speed, battery classification for the battery pack, C- and E-rates for the battery pack, stored energy capacity or nominal capacity, energy or nominal energy (Wh for a specific C-rate), cycle life (number for a specific DOD), specific energy, specific power, energy density, power density, maximum continuous discharge current, maximum 30-second discharge pulse current, charge voltage, float voltage, (recommended) charge current, (maximum) internal resistance, terminal voltage, open-circuit voltage, internal resistance, nominal voltage, cut-off voltage, winding temperature, rotor speed, battery pack voltage level, output electrical current, electrical current direction of flow, leakage current, battery pack temperature, depth-of-charge, state-of-charge, or state-of-health, or state-of-function, throttle position, manifold pressure, engine coolant temperature, mass air flow, camshaft position, crankshaft position, oxygen, detonation, EGR, intake air temperature, engine speed, brake or accelerator pedal position, and brake pad wear.

The user interface 2120 receives user commands and other input, such as user selections, preferences, and settings that are used in configuring, determining, and selecting subsets of possible routes, provides navigation information, including possible routes for user selection, updated route information during vehicle travel, and other navigation information, and other vehicular information. The user interface 2120 can be one or more of vehicle instrument panel 400, vehicle operational display 420, heads-up display 434, and power management display 428. It can also be a portable computational or communication device of an occupant.

The navigation information 2124 can take many forms depending on the configuration. When the various inputs received by the vehicle navigation system 2104 are provided, via network 1909, to the map database manager 2012, it can be the map or other navigation information provided to the occupant, including possible subset of routes and periodically updated selected route map information. When the various inputs are received by the vehicle navigation system 2104, which then configures, determines or selects subsets of possible routes, it is map information from the map database 2016 that is selected based on a request received by the map database manager 2012 from the vehicle 120. The request can include the current vehicle location as determined by the automatic vehicle location system 2108 and the locations of the user selected waypoints and destination. The map information can include not only two-dimensional map information but also the topography of each roadway segment in the map information. Topography refers to a map depicting in detail ground relief (landforms and terrain), drainage (lakes and rivers), forest cover, administrative areas, populated areas, transportation routes and facilities (including roads and railways), and other man-made features. The map information can also include stopping points for vehicles, such as intersections and traffic stop signs and signals, speed limits, current traffic levels (e.g., heavy, light, and levels in between), current traffic movement speeds, and the like.

The map information can be used by the vehicle navigation system 2104 or map database manager 2012 to determine and assign, for at least a portion of each possible route and using an aggregate energy usage or consumption indicator, an expected, projected, or probable energy usage required to travel the portion of the route. The aggregate energy usage or consumption indicator can be based on one or more of the current battery classification for the battery pack, C- and E-rates for the battery pack, stored energy capacity or nominal capacity, energy or nominal energy (Wh for a specific C-rate), cycle life (number for a specific DOD), specific energy, specific power, energy density, power density, maximum continuous discharge current, maximum 30-second discharge pulse current, charge voltage, float voltage, (recommended) charge current, (maximum) internal resistance, terminal voltage, open-circuit voltage, internal resistance, nominal voltage, cut-off voltage, winding temperature, rotor speed, battery pack voltage level, output electrical current, electrical current direction of flow, leakage current, battery pack temperature, depth-of-charge, state-of-charge, or state-of-health, or state-of-function in or of the electrical storage unit 612 or battery pack, rotor speed, output electrical current, electrical current direction of flow, leakage current, and/or battery pack temperature. Stated differently, the aggregate energy usage or consumption indicator can be used to determine, for the portion of the route, the distance or route segment(s) the vehicle can travel 120 without (re)charging, or the portion of the route along which a charging facility or station must be located. These criteria can be used to further filter the possible routes to form a further filtered subset of possible routes

For each further filtered subset of routes, the facility or station information provided by the charging station server(s) 2008A-M lying along the route is used to estimate whether the charging facility or station is (a) acceptable to the user (e.g., satisfies user historic or selected preferences for charging type, wait time, available automation level, charge rate, cost, shielding, and the like), (b) appropriate facility or station for the vehicle 120 (e.g., is of the proper charging type, has compatible charging panel types, has compatible vehicle storage units, and the like to charge the vehicle), or (c) otherwise available to the vehicle 120 (e.g., is currently or will be open or has an available reservation or availability to the vehicle (that is will have the appropriate charging service status)).

Routes satisfying criteria (a) through (c) are the subset of routes presented to the user for selection.

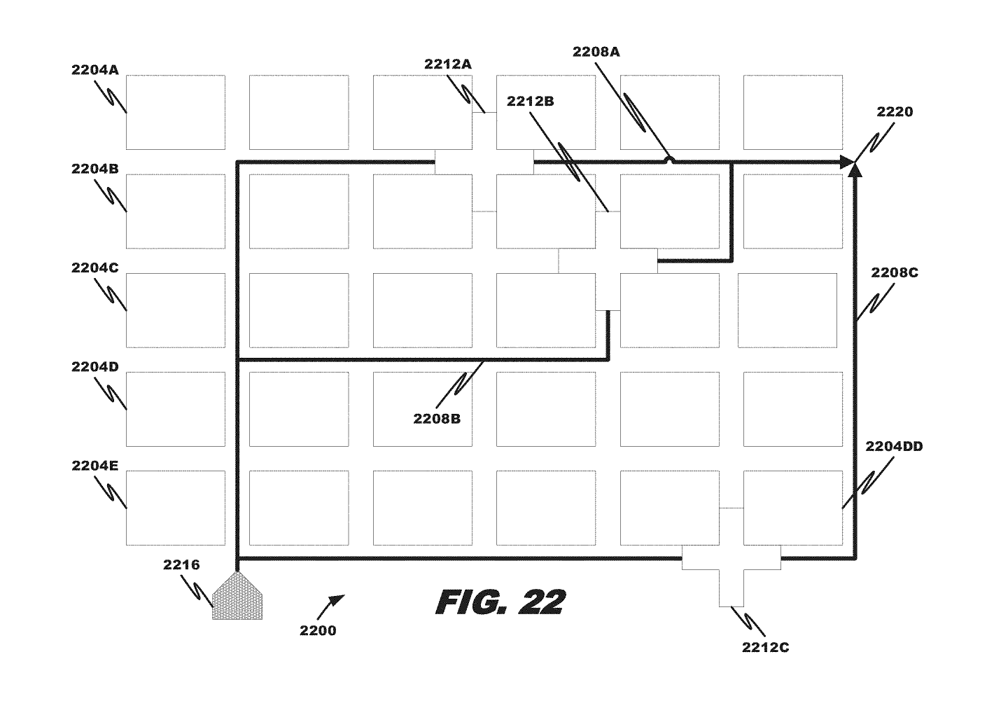

An illustrative map presented to the user via user interface is shown in FIG. 22. The map 2200 comprises multiple city blocks 2204A-DD separated by intervening city streets. First, second, and third routes 2208A-C are depicted, with each route having a corresponding charging facility or station 2212A-C. The current position of the vehicle is depicted by polygon 2216 and the destination or waypoint is depicted by point 2220. The locations of the charging facilities or stations 2212A-C along each of the first, second, and third routes 2208A-C are selected such that the on board energy storage of the vehicle 120 is sufficient to enable the vehicle 120 to arrive at each of the locations.

The routes can be further described by comparative criteria relative to other presented routes, e.g., a first route can be described as the route using least amount of stored energy (e.g., having the best topography for energy consumption), a second route being the route having the shortest charging wait time, a third route being the route regenerating the most electrical energy, a fourth route being the route having the least expensive charging facilities or stations, a fifth route being the most scenic route, a sixth route being the route having the highest charging rate, etc.

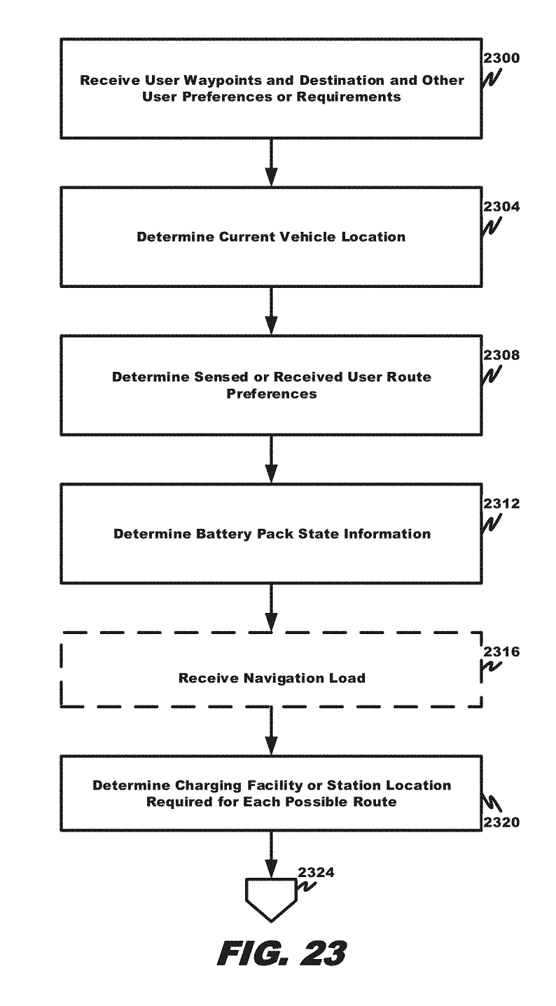

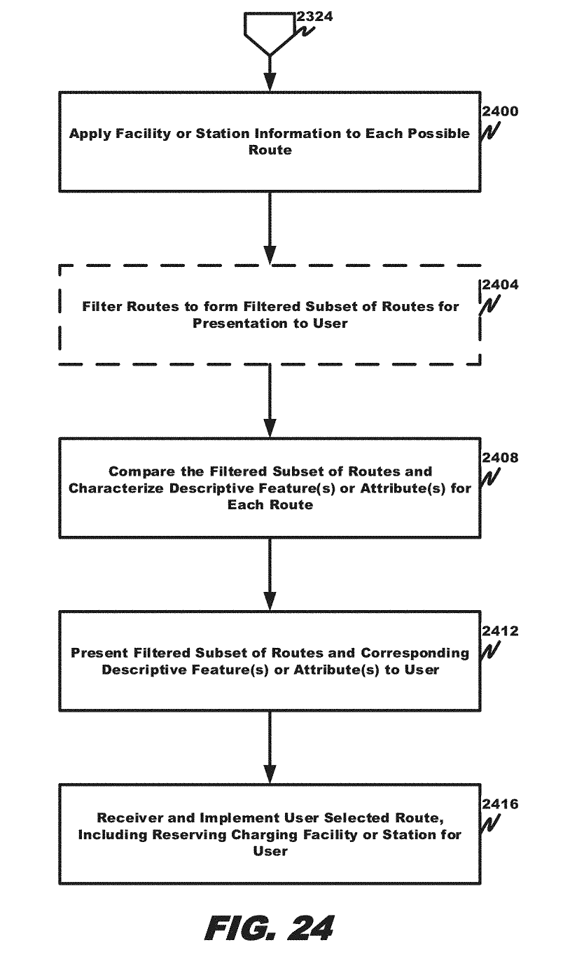

With reference to FIGS. 23 and 24, a flow chart according to an embodiment will be discussed.

In step 2300, the user or vehicle operator configures the route subset to be generated by the vehicle navigation system 2104 or map database manager 2012. The user or operator inputs into the user interface 2120 selected user waypoints and the route destination. Other information can be provided depending on the configuration. For instance, the user or operator can input into the user interface 2120 other route parameters, such as any of the auxiliary data to be used to filter one or more selected routes from among the numerous possible routes.

In step 2304, the vehicle navigation system 2104 or map database manager 2012 determines the current vehicle location, such as by receiving input from the automatic vehicle location system 2108 in response to a query.

In step 2308, the vehicle navigation system 2104 or map database manager 2012 determines the sensed or received user route preferences, such as by receiving further input (e.g., auxiliary data and the like) from the user interface 2120 or retrieving sensed user data 2116 from an on board or remotely located computer readable medium.

In step 2312, the vehicle navigation system 2104 or map database manager 2012 determines battery pack state information from one or more of the charge management unit 1708, sensor connectivity manager 1966, or power management controller 1324.

In optional step 2316, the vehicle navigation system 2104 receives spatial map information from the map database manager 2012 and map database 2016. This step is performed when the route configuration, determination and provision is performed local by the vehicle navigation system 2104 of the vehicle 120.

In step 2320, the vehicle navigation system 2104 or map database manager 2012 determines the charging facility or station location required for each possible route. This can be done by assigning to each roadway segment an energy usage or consumption indicator indicating energy usage or consumption under selected conditions along the roadway segment and projecting a travel distance the vehicle 120 can travel along the selected route based on the. stored energy capacity or nominal capacity, energy or nominal energy (Wh for a specific C-rate), specific energy, specific power, energy density, power density, maximum continuous discharge current, (maximum) internal resistance, leakage current, battery pack temperature, depth-of-charge, state-of-charge, state-of-health, or state-of-function in or of the electrical storage unit 612 or battery pack. As will be appreciated, the energy usage or consumption indicator can be a function of many parameters, including roadway surface conditions (e.g., ice or snow packed, icy, wet, paved, gravel, etc.), roadway topography (e.g., flat or planar, sloping upwardly or downwardly, etc.), traffic signals or signs along the roadway segment (e.g., stop sign, stop light, etc.), traffic congestion level along the roadway segment, predicted speed of travel along the roadway segment (which can be a function of, e.g., legal speed limit, traffic congestion level, user or operator historic behavior, and the like), vehicle-related parameters (e.g., vehicle weight and energy consumption efficiency), vehicle load (e.g., occupant and passenger weight, luggage weight, and the like), and environmental conditions (e.g., wind resistance, ambient temperature, etc.). The assigned energy usage or consumption indicator can be determined for historic averages for the above parameters (which can be further broken down seasonally, monthly, weekly, daily, or by time-of-day), current parameter settings or values (e.g., based on current values for roadway surface conditions, roadway topography, traffic signals or signs along the roadway segment, traffic congestion level along the roadway segment, predicted speed of travel along the roadway segment, vehicle-related parameters, vehicle load, and environmental conditions, “worst case” parameter settings or values, or a combination thereof. Each parameter setting or value (which represents a contribution of the corresponding parameter to vehicle energy consumption) is combined to yield the composite energy usage or consumption indicator for the corresponding roadway segment. Any route is a combination of selected roadway segments; therefore, an aggregate energy usage or consumption indicator can be determined by summing or otherwise combining the composite energy usage or consumption indicators corresponding to each component roadway segment.

As shown by arrow 2324, the vehicle navigation system 2104 or map database manager 2012 obtains the facility or station information from the map database and applies the facility or station information to each possible route to locate suitable facilities or stations for the vehicle 120 and user preferences. The locations can be shown only for those facilities or stations within the driving range of the vehicle 120 along the corresponding route.

In step 2404, the vehicle navigation system 2104 or map database manager 2012 filters the routes not complying with one or more selected criteria to form a filtered subset of routes for presentation to the user. The criteria, for example, include the existence or nonexistence of a suitable facility or station within the driving range of the vehicle 120.

In step 2408, the vehicle navigation system 2104 or map database manager 2012 compares the filtered subset of routes and characterizes a descriptive feature or attribute for each route member. The descriptive features or attributes include any of the features and attributes referenced above.

In step 2412, the vehicle navigation system 2104 or map database manager 2012 presents the filtered subset of routes and corresponding descriptive feature(s) or attributes(s) to the user via the user interface in the vehicle 120.

In step 2416, the vehicle navigation system 2104 receives the user selected route, updates the interface to display only the selected route, and implements the selected route, such as by making a reservation for the vehicle 120 at the charging facility or station (selected by the user) in the selected route.

In another embodiment, the vehicle navigation system 2104 or map database manager 2012, in step 2408, applies previously received user preferences in step 2300 to select only one route for presentation or display to the user in step 2412. In this embodiment, steps 2412 and 2416 are combined such that the vehicle navigation system 2104 also implements the displayed route.

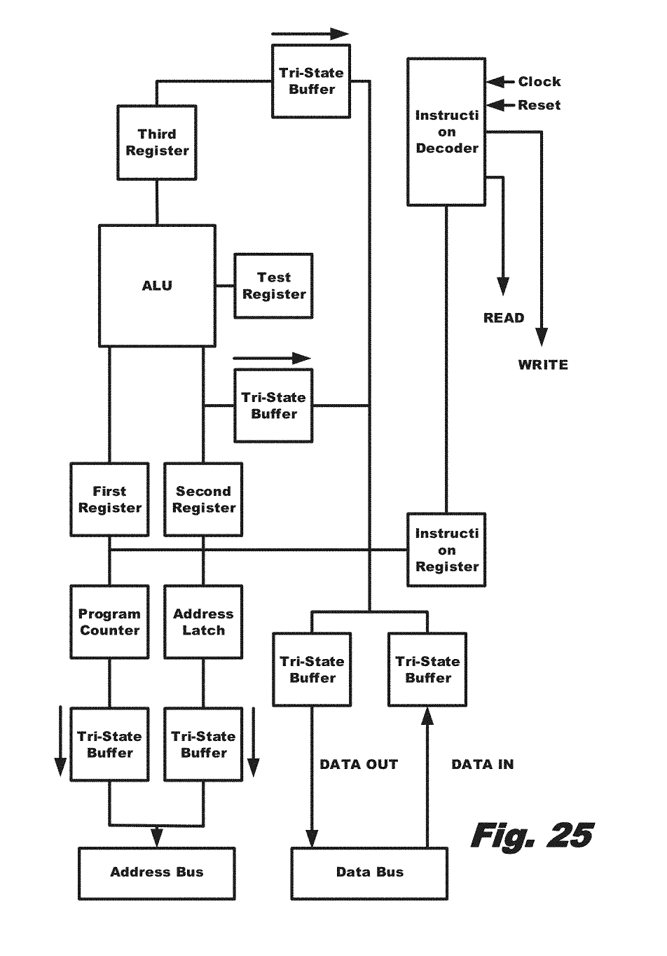

With reference to FIG. 25, the logical instructions are executed by an arithmetic/logic unit (“ALU”), which performs mathematical operations, such as addition, subtraction, multiplication, and division, machine instructions, an address bus (that sends an address to memory), a data bus (that can send data to memory or receive data from memory), a read and write line to tell the memory whether to set or get the addressed location, a clock line that enables a clock pulse to sequence the processor, and a reset line that resets the program counter to zero or another value and restarts execution. The arithmetic/logic unit can be a floating point processor that performs operations on floating point numbers. The vehicle navigation system 2104 and/or map database manager 2012 further includes first, second, and third registers that are typically configured from flip-flops, an address latch, a program counter (which can increment by “1” and reset to “0”), a test register to hold values from comparisons performed in the arithmetic/logic unit (such as comparisons in steps 2404 and 2408), plural tri-state buffers to pass a “1” or “0” or disconnect its output (thereby allowing multiple outputs to connect to a wire but only one of them to actually drive a “1” or “0” into the line), and an instruction register and decoder to control other components. Control lines, in the vehicle navigation system 2104 and/or map database manager 2012, from the instruction decoder can: command the first register to latch the value currently on the data bus, command the second register to latch the value currently on the data bus, command the third register to latch the value currently output by the ALU, command the program counter register to latch the value currently on the data bus, command the address register to latch the value currently on the data bus, command the instruction register to latch the value currently on the data bus, command the program counter to increment, command the program counter to reset to zero, activate any of the plural tri-state buffers (plural separate lines), command the ALU what operation to perform, command the test register to latch the ALU's test bits, activate the read line, and activate the write line. Bits from the test register and clock line as well as the bits from the instruction register come into the instruction decoder. Hardware similar or identical to that of FIG. 25 is in each of the vehicle navigation system 2104 and/or map database manager 2012 for executing the instructions of FIGS. 23-24. The ALU executes instructions for a random or pseudo-random number generation algorithm and generates the recipient identifier using the appropriate seed values.

Trip Planning Through Charging Stations

Disclosed herein are various systems and methods of automatically planning routes despite possible uncertainties. Today's drivers rely on computer navigation systems for a number of crucial reasons. For example, navigation systems may be used to provide accurate directions, to determine a time-efficient route, to determine an energy-efficient route, etc. Increased computing power and inexpensive memory have led to a proliferation of data than can be used to augment existing navigation systems. As the number of electric vehicles on today's roads increases, the demand for charging stations similarly increases. When planning a route, a driver of an electric vehicle likely will be unaware or uncertain of locations of charging stations along the way. Moreover, the driver will likely fail to have knowledge of at what points along a route the car may need to be recharged. Furthermore, the driver cannot be aware or have knowledge of factors affecting the ETA such as wait times of various charging stations, charging time differences between different stations, and amount of delay due to traffic. The present disclosure describes a system for real-time routing of an electric vehicle from a start location to a destination through a network of charging stations. The system leverages both historical and real-time charging and queue times at charging stations, as well as real-time traffic, to optimize a routing objective.

While determining a shortest distance between a starting location and a destination and choosing a number of charging stations based on a measured increase to the total distance may be straightforward, choosing particular charging stations based on a predicted effect on the ETA may be more complex. Charging stations may vary in factors such as estimated charging time for a particular vehicle and estimated waiting time for an arrived vehicle to begin charging. Such factors may also depend on a time of day, day of week, time of year, etc.

In some embodiments, a method may be implemented to automatically route an electric vehicle from a start location to a destination through a network of charging stations explicitly considering time-varying uncertainty in a number of factors, including charging times, queueing times, vehicle range, etc.

An input to the system may include one or more of the location of charging stations, historical and real-time charging and queue times, and one or more routing objectives. A routing objective may be a function of trip duration, electric vehicle state of charge at any time or location along the trip, uncertainty in the vehicle state of charge, uncertainty in the estimated trip duration, estimated cost, etc. Uncertainty in a distribution may be computed using an information-theoretic metric such as entropy.

Distributions over quantities that impact the routing objective are estimated using both historical and real-time data. These distributions may be explicitly considered by making the routing objective a function of one or both of the distributions themselves and a statistic summarizing characteristics of these distributions (e.g., mean charging time, mean waiting time, etc.).

Once distributions over the quantities of interest have been estimated, the problem of finding an optimal planned route through a network of charging stations can be posed as solving a partially observable Markov decision process (POMDP), a principled approach to sequential decision making under uncertainty. A POMDP is a generalized version of a Markov decision process allowing for uncertainties and incomplete data with regard to states of the system. Using the data at hand in real time regarding distributions of possible charging times, traffic, queueing times, a vehicle navigation system may estimate an optimal planned route despite uncertainties.

At each time step, solving the POMDP may yield an optimal planned route given current estimates of queue times, charging times, state of charge, traffic, and learned uncertainty in those quantities. In practice, a navigation system may plan and re-plan routes in real-time, always explicitly considering the ability to plan to re-plan. An example of planning to re-plan may be taking a road that may encounter traffic if it is estimated that an adjacent road may clear by the time the traversed road becomes congested.

POMDPs are difficult to solve due to the well-known curses of dimensionality and history. State-of-the-art reinforcement learning techniques can be used to find approximate solutions to the POMDP in real-time. These approaches include partially observable Monte Carlo planning (an extension of the Monte Carlo tree search algorithm), value function approximation methods, and partially observable deep reinforcement learning.

Estimating Waiting and Charging Times

In some embodiments, estimated waiting times at electric vehicle charging stations given observed data for each station may be determined. An estimated waiting time at a charging station can be communicated directly to the owner of an electric vehicle owner or used by a computer navigation system for routing the vehicle through charging stations.

Predicting waiting times at a charging station is nontrivial because there is no established method of documenting how long drivers wait for a charging station to become available. A charging station may be located in a retail center or apartment complex or other location where there is inadequate space for vehicles to form a “queue.” Accordingly, vehicles waiting for a charging may form an informal queue by loitering in the vicinity of the station or parking nearby. Because there is no obvious way to measure the length of this informal queue, there is no way of predicting how long that queue and the corresponding wait time will be for a driver interested in charging at a station. Disclosed herein is a system for predicting waiting times at charging stations that leverages a record of the “time in use” at a charging station to infer a length of the queue and thereby predict an estimated waiting time. The presently disclosed system leverages a queuing-theoretic model of demand at charging stations whose parameters are learned using actual observations at those stations.

The proposed system may in some embodiments comprise two parts: (1) collecting observed data at one or more charging stations, and (2) predicting a distribution over estimated wait times.

First, observed data at one or more charging stations may be collected. Such data may include a record of when the charging station is in use. Additional data useful for wait time prediction may include location of the charging station, vehicle type of a vehicle currently charging, a current charging time of the vehicle currently charging, an amount of power being drawn, and initial and/or final state of charge of the vehicle currently charging.

Second, a distribution over estimated wait time for the charging station may be predicted. The predicted distribution may take into account whether the charging station in question is currently in use, the type of vehicle charging, initial charging time, power draw, and initial state of charge.

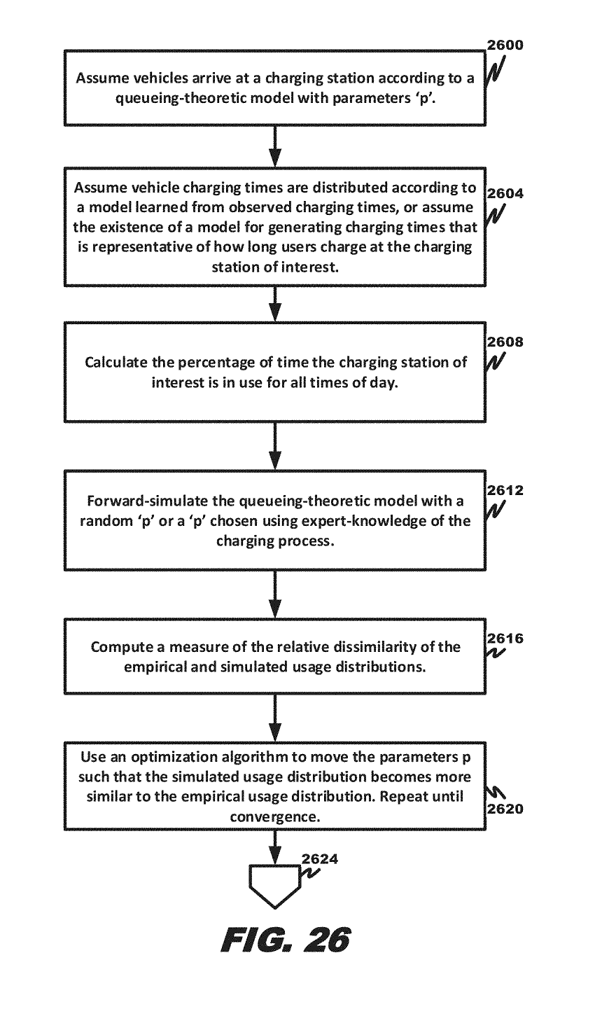

This second step of the system may consist of estimating the parameters of a process describing the arrival of vehicles to the charging station, then using that process to simulate vehicles arriving and departing from the charging station for a single day. Millions of simulations may be performed, and the time every vehicle had to wait for a charging station for each simulation may recorded. These recorded waiting times may be used to form a distribution to be used as a predicted waiting time for a vehicle traveling to that charging station. The process, illustrated in the flowchart of FIG. 26, may be as outlined below:

(A) Assume vehicles arrive at a charging station according to a queueing-theoretic model with parameters ‘p’ at step 2600. The variable ‘p’ may be a vector of real-valued numbers or a function estimable using calculus of variations.

(B) Assume vehicle charging times are distributed according to a model learned from observed charging times, or assume the existence of a model for generating charging times that is representative of how long users charge at the charging station of interest at step 2604.

(C) Calculate the percentage of time the charging station of interest is in use for all times of day at step 2608. We call this the ‘usage distribution.’ In this case, because the distribution is determined from empirical data, we will call it the ‘empirical usage distribution.’

(D) Forward-simulate the queueing-theoretic model with a random ‘p’ or a ‘p’ chosen using expert-knowledge of the charging process at step 2612. Using many simulations, a simulated version of the usage distribution may be computed.

(E) Compute a measure of the relative dissimilarity of the empirical and simulated usage distributions at step 2616.

(F) Use an optimization algorithm to move the parameters p such that the simulated usage distribution becomes more similar to the empirical usage distribution at step 2620. Repeat until convergence. We call the parameters at convergence, p*, the ‘optimal’ parameters, in that the queuing-theoretic process with parameters p* is likely to be representative of the underlying process determining the rate of arrival at the charging station in question.

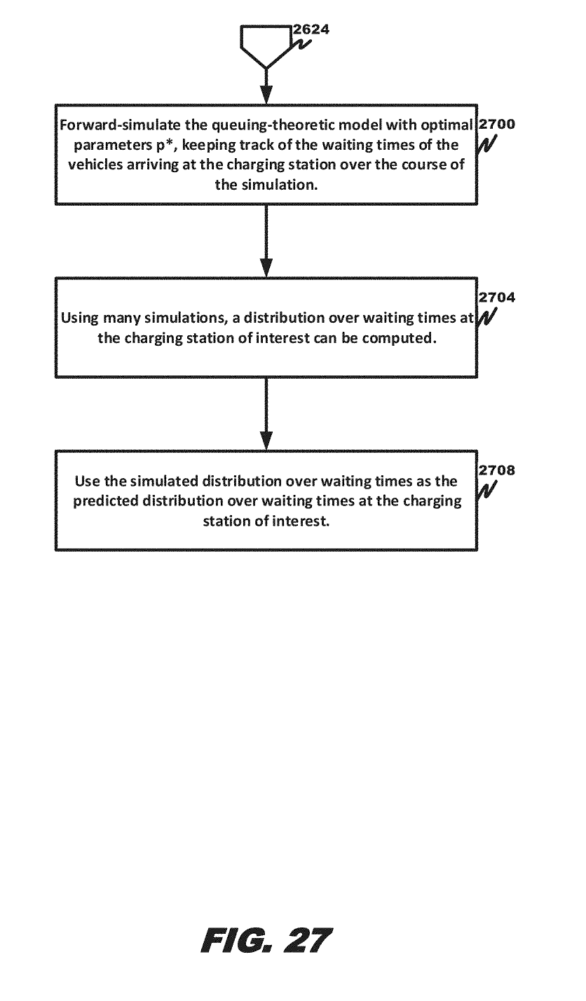

As shown by arrow 2624, the method flowchart continues with FIG. 27.

(G) Forward-simulate the queuing-theoretic model with optimal parameters p*, keeping track of the waiting times of the vehicles arriving at the charging station over the course of the simulation at step 2700. Using many simulations, a distribution over waiting times at the charging station of interest can be computed at step 2704.

(H) Use the simulated distribution over waiting times as the predicted distribution over waiting times at the charging station of interest at step 2708. As can be appreciated, the estimation of wait time may be extended and be applied to other types of queues, e.g., toll booths and traffic jams. Real-time information from other vehicles on the road may also be used in determining or estimating a particular wait time. As discussed below, the predicted waiting time or estimated queue time may be used along with other data in calculating or estimating a range of a vehicle.

Estimating Vehicle Range

In some embodiments, the range at the beginning of each trip, i.e. Average Remaining Range, as well as a Route-based Range Prediction which may update during and throughout the trip based on several features such as driving behavior, route elevation profile and temperature may be estimated.

First, a Route-based Range prediction algorithm may comprise in some embodiments one or more of two steps, as discussed in further detail below, (1) predicting a total power consumption for a given route at the beginning of a trip; and (2) updating the prediction of the total power consumption in real-time at periods throughout the trip. Second, an Average Remaining Range may be estimated using both historical data and the Route-based Range prediction algorithm.

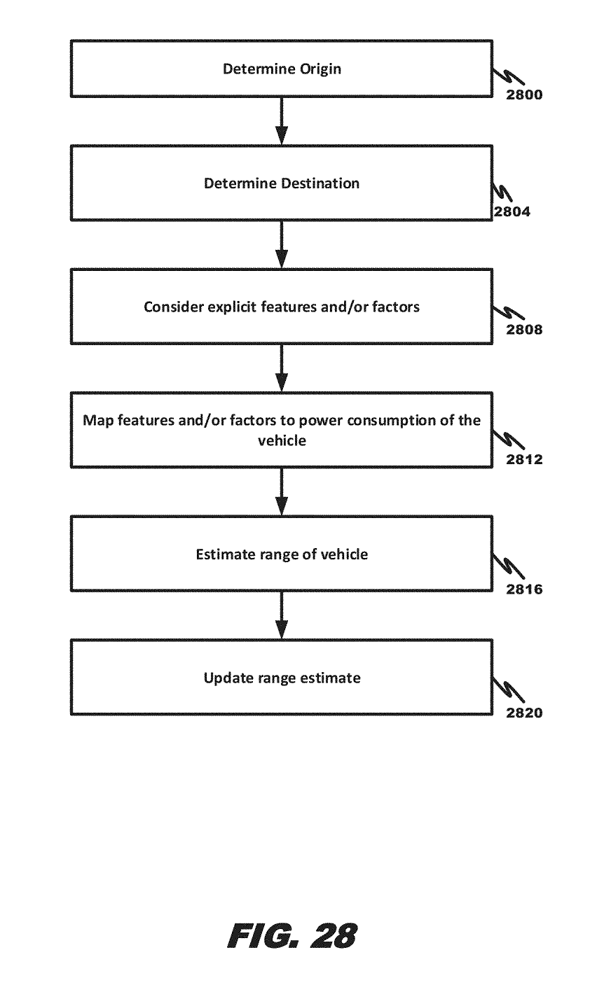

As illustrated in FIG. 28, a route-based range prediction algorithm may comprise predicting a total amount of power consumption required for a given route. The prediction may be made at a beginning of a trip or upon a user entering a starting location and/or a destination into a user interface. In some embodiments the starting location, or origin, may automatically be determined based on a user's current location 2800.

The route-based range prediction algorithm may further comprise determining a destination 2804. The destination may be determined based on a user input into a user interface of the vehicle. In other embodiments, the destination may be predicted or estimated based on past trips, for example a user may have a recurring drive such as a commute between work and home.

Upon determining the origin and destination, one or more routes may be generated.

In order to predict a power consumption for a particular route, explicit features and factors may be considered 2808. For example, in some embodiments, factors including, but not limited to, total distance of the route to the destination, elevation changes in the route, temperature, windspeed and wind-direction, drag coefficient of the vehicle, weight of the vehicle including occupants, and other factors may be considered. The current occupancy weight may be determined from weight sensors within each seat, or from other sensors throughout the vehicle. Occupancy changes may also be predicted based on events in electronic calendars of the driver and/or passengers.

A user's driving behavior and HVAC consumption may also be modeled and considered in the prediction calculation. Driving behavior may be modeled using recorded telemetry data such as GPS, speed, acceleration usage, and/or brake usage. HVAC consumption may be predicted based on a user's historical behavior and the predicted temperature. contextual information from the car (for example, time in autonomous mode, predicted driver behavior, occupancy, predicted weather based on exterior sensors, etc.) to predict and optimize range coupled with algorithms for estimating charging and queue times at charging stations for effectively planning charging stops as discussed above.

Using historical data, machine learning algorithms may map these features to the power consumption in the car 2812. Historical data may be collected from actual use of the vehicle or in some embodiments it may be data collected from similar vehicles. For example, a number of network connected vehicles may collect data on users' driving behaviors, HVAC consumption, and other explicit features and factors. The energy usage associated with such factors may be collected. Such data may be collected and stored on a network database. A network average may be determined and the data may be available to other vehicles to determine an estimated power consumption value for a given set of explicit features and factors.

Given the power consumption value and the initial SoC of the vehicle's battery, a range of the vehicle may be estimated 2816. For example, a battery at 50% SoC combined with a power consumption value of 10% per hour may have an estimated range of five hours. In some embodiments, the range may be measured in distance (e.g., miles, kilometers, etc.) or time (e.g. hours, minutes, seconds).

Predictions may be updated in real time, periodically, or at particular points during a journey 2820. In order to improve the predicted range, a reinforcement learning algorithm may be implemented which continuously takes the current driving profile, temperature and battery's SoC as input and updates the predicted driving profile and HVAC consumption.

Next, an average remaining range may be estimated using power consumption value, historic data and the Route-based Range prediction algorithm discussed above. For example, predicted wait times at charging stations and estimated charging times in combination with estimated power consumption during a route given explicit features and other factors may be combined to calculate an average remaining range. In some embodiments, a navigation system may present a number of possible routes for a user to select from. In such a scenario, the route that the user will use may not be known. As such, the average remaining range over all estimated ranges for the different types of routes may be determined.

Any of the steps, functions, and operations discussed herein can be performed continuously and automatically.

The exemplary systems and methods of this disclosure have been described in relation to vehicle systems and electric vehicles. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a method of routing a rechargeable electric vehicle, the method comprising: determining, by an automatic vehicle location system, an origin based on input from a satellite location system, determines a current spatial location of the rechargeable electric vehicle relative to a selected coordinate system; determining, by a vehicle navigation system, a destination; determining, by the vehicle navigation system, a range of the vehicle; and determining, by the vehicle navigation system, a route for the vehicle from the origin to the destination, wherein the route comprises at least a first stop at a first charging station, wherein the route is determined based on an estimated wait time at the first charging station.

Aspects of the above method can include wherein the estimated wait time is determined based on a partially observable Markov decision process.

Aspects of the above method can include wherein the route is an optimal planned route based on the estimated wait time and an estimated charging time of the electrical vehicle.

Aspects of the above method can include wherein the route is further determined based on an estimated charging time.

Aspects of the above method can include wherein the estimated charging time is based on an estimated charge level at an estimated time of arrival at the charging station.

Aspects of the above method can include wherein the route is further determined based on real time and historical traffic data.

Aspects of the above method can include wherein the route further comprises a second stop at a second charging station.

Aspects of the above method can include wherein the estimated wait time at the first charging station is determined based at least in part on one or more of historical waiting data for the first charging station and real time waiting data for the first charging station.

Aspects of the above method can include wherein the estimated wait time at the first charging station is determined based at least in part on a simulation of vehicles arriving at the first charging station.

Embodiments include a system, comprising: a processor; and a computer-readable storage medium storing computer-readable instructions, which when executed by the processor, cause the processor to perform operations comprising: determining, by an automatic vehicle location system of a rechargeable electric vehicle and, based on input from a satellite location system an origin based on input from a satellite location system, determines a current spatial location of the rechargeable electric vehicle relative to a selected coordinate system; determining a destination; determining a range of the vehicle; and determining a route for the vehicle from the origin to the destination, wherein the route comprises at least a first stop at a first charging station, wherein the route is determined based on an estimated wait time at the first charging station.

Aspects of the above system can include wherein the estimated wait time is determined based on a partially observable Markov decision process.

Aspects of the above system can include wherein the route is an optimal planned route based on the estimated wait time and an estimated charging time of the electrical vehicle.

Aspects of the above system can include wherein the route is further determined based on an estimated charging time.

Aspects of the above system can include wherein the estimated charging time is based on an estimated charge level at an estimated time of arrival at the charging station.

Aspects of the above system can include wherein the route is further determined based on real time and historical traffic data.

Aspects of the above system can include wherein the route further comprises a second stop at a second charging station.

Aspects of the above system can include wherein the estimated wait time at the first charging station is determined based at least in part on one or more of historical waiting data for the first charging station and real time waiting data for the first charging station.

Aspects of the above system can include wherein the estimated wait time at the first charging station is determined based at least in part on a simulation of vehicles arriving at the first charging station.

Embodiments include a computer program product, comprising: a non-transitory computer readable storage medium having computer readable program code embodied therewith, the computer readable program code configured [when executed by a processor] to: determining, by an automatic vehicle location system of a rechargeable electric vehicle and, based on input from a satellite location system an origin based on input from a satellite location system, determines a current spatial location of the rechargeable electric vehicle relative to a selected coordinate system; determining a destination; determining a range of the vehicle; and determining a route for the vehicle from the origin to the destination, wherein the route comprises at least a first stop at a first charging station, wherein the route is determined based on an estimated wait time at the first charging station.

Aspects of the above computer program product can include wherein the estimated wait time is determined based on a partially observable Markov decision process.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “electric vehicle” (EV), also referred to herein as an electric drive vehicle, may use one or more electric motors or traction motors for propulsion. An electric vehicle may be powered through a collector system by electricity from off-vehicle sources, or may be self-contained with a battery or generator to convert fuel to electricity. An electric vehicle generally includes a rechargeable electricity storage system (RESS) (also called Full Electric Vehicles (FEV)). Power storage methods may include: chemical energy stored on the vehicle in on-board batteries (e.g., battery electric vehicle or BEV), on board kinetic energy storage (e.g., flywheels), and/or static energy (e.g., by on-board double-layer capacitors). Batteries, electric double-layer capacitors, and flywheel energy storage may be forms of rechargeable on-board electrical storage.

The term “hybrid electric vehicle” refers to a vehicle that may combine a conventional (usually fossil fuel-powered) powertrain with some form of electric propulsion. Most hybrid electric vehicles combine a conventional internal combustion engine (ICE) propulsion system with an electric propulsion system (hybrid vehicle drivetrain). In parallel hybrids, the ICE and the electric motor are both connected to the mechanical transmission and can simultaneously transmit power to drive the wheels, usually through a conventional transmission. In series hybrids, only the electric motor drives the drivetrain, and a smaller ICE works as a generator to power the electric motor or to recharge the batteries. Power-split hybrids combine series and parallel characteristics. A full hybrid, sometimes also called a strong hybrid, is a vehicle that can run on just the engine, just the batteries, or a combination of both. A mid hybrid is a vehicle that cannot be driven solely on its electric motor, because the electric motor does not have enough power to propel the vehicle on its own.

The term “rechargeable electric vehicle” or “REV” refers to a vehicle with on board rechargeable energy storage, including electric vehicles and hybrid electric vehicles.

What is claimed is:

1. A method of routing a rechargeable electric vehicle, the method comprising:
determining, by an automatic vehicle location system, an origin based on input from a satellite location system;
determining a current spatial location of the rechargeable electric vehicle relative to a selected coordinate system;
determining, by a vehicle navigation system, a destination;
determining, by the vehicle navigation system, an estimated range of the vehicle; and
determining, by the vehicle navigation system, a route for the vehicle from the origin to the destination, wherein the route comprises at least a first stop at a first charging station, wherein the route is determined based on an estimated wait time at the first charging station.

2. The method of claim 1, further comprising updating the estimated range of the vehicle based on the estimated wait time at the first charging station.

3. The method of claim 1, wherein the route is an optimal planned route based on the estimated wait time and an estimated charging time of the electrical vehicle.

4. The method of claim 1, wherein the route is further determined based on an estimated charging time.

5. The method of claim 4, wherein the estimated charging time is based on an estimated charge level at an estimated time of arrival at the charging station.

6. The method of claim 1, wherein the route is further determined based on real time and historical traffic data.

7. The method of claim 1, wherein the route further comprises a second stop at a second charging station.

8. The method of claim 1, wherein the estimated wait time at the first charging station is determined based at least in part on one or more of historical waiting data for the first charging station and real time waiting data for the first charging station.

9. The method of claim 1, wherein the estimated wait time at the first charging station is determined based at least in part on a simulation of vehicles arriving at the first charging station.

10. A system, comprising:
a processor; and
a computer-readable storage medium storing computer-readable instructions, which when executed by the processor, cause the processor to perform operations comprising:
determining, by an automatic vehicle location system of a rechargeable electric vehicle based on input from a satellite location system, an origin based on input from a satellite location system;
determining a current spatial location of the rechargeable electric vehicle relative to a selected coordinate system;
determining a destination;
determining a range of the vehicle; and
determining a route for the vehicle from the origin to the destination, wherein the route comprises at least a first stop at a first charging station, wherein the route is determined based on an estimated wait time at the first charging station.

11. The system of claim 10, wherein the estimated wait time is determined based on a partially observable Markov decision process.

12. The system of claim 10, wherein the route is an optimal planned route based on the estimated wait time and an estimated charging time of the electrical vehicle.

13. The system of claim 10, wherein the route is further determined based on an estimated charging time.

14. The system of claim 13, wherein the estimated charging time is based on an estimated charge level at an estimated time of arrival at the charging station.

15. The system of claim 10, wherein the route is further determined based on real time and historical traffic data.

16. The system of claim 10, wherein the route further comprises a second stop at a second charging station.

17. The system of claim 10, wherein the estimated wait time at the first charging station is determined based at least in part on one or more of historical waiting data for the first charging station and real time waiting data for the first charging station.

18. The system of claim 10, wherein the estimated wait time at the first charging station is determined based at least in part on a simulation of vehicles arriving at the first charging station.

19. A computer program product, comprising:
a non-transitory computer readable storage medium having computer readable program code embodied therewith, the computer readable program code configured, when executed by a processor, to:
determine, by an automatic vehicle location system of a rechargeable electric vehicle and based on input from a satellite location system, an origin based on input from a satellite location system;
determine a current spatial location of the rechargeable electric vehicle relative to a selected coordinate system;
determine a destination;
determine a range of the vehicle; and
determine a route for the vehicle from the origin to the destination, wherein the route comprises at least a first stop at a first charging station, wherein the route is determined based on an estimated wait time at the first charging station.

20. The computer program product of claim 19, wherein the estimated wait time is determined based on a partially observable Markov decision process.
